(19) United States
(12) Patent Application Publication
(10) Pub. No.: US 2016/0188681 A1
(43) Pub. Date: Jun. 30, 2016

(54) Viewing Search Results Using Multiple Different Devices

(71) Applicant: Quixey, Inc., Mountain View, CA (US)

(72) Inventors: Taher Savliwala, Mountain View, CA (US); Jonathan Ben-Tzur, Sunnyvale, CA (US); Tomer Kagan, Sunnyvale, CA (US); Liron Shapira, Mountain View, CA (US)

(73) Assignee: Quixey, Inc., Mountain View, CA (US)

(21) Appl. No.: 14/876,617

(22) Filed: Oct. 6, 2015

Related U.S. Application Data
(60) Provisional application No. 62/097,329, filed on Dec. 29, 2014.

(51) Int. Cl. G06F 17/30; G06F 3/0484

(52) U.S. Cl. CPC G06F 17/30554; G06F 3/0484; G06F 17/30424

(57) ABSTRACT

Techniques include transmitting, using a searching device, a search query to a search system, and selecting, also using the searching device, one of a plurality of viewing devices to view results of the search (e.g., based on a user input or other considerations). The techniques further include receiving search results from the search system at the selected viewing device in response to transmitting the search query. In this example, each search result indicates a function for a computing device to perform. The techniques also include displaying the search results on the viewing device, receiving a user selection of one of the search results at the viewing device, and transmitting, using the viewing device, an indication of the user selection to a performing device. In this example, the performing device is configured to perform the function indicated by the selected search result in response to receiving the indication.

### CROSS-REFERENCE TO RELATED APPLICATION

This U.S. patent application claims priority under 35 U.S.C. §119(e) to U.S. Provisional Application No. 62/097,329, filed Dec. 29, 2014, which is hereby incorporated by reference in its entirety.

### TECHNICAL FIELD

This disclosure generally relates to the field of search, and more particularly to generating, displaying, and accessing search results on computing devices.

### BACKGROUND

In recent years, the use of computers, smartphones, and other Internet-connected computing devices has grown significantly. Correspondingly, the number of software applications (apps) available for such devices has also grown. Today, many diverse software apps can be accessed on a number of different computing devices, including smartphones, personal computers, automobiles, and televisions. These software apps can include business driven apps, games, educational apps, news apps, shopping apps, messaging apps, media streaming apps, and social networking apps, as some examples. Because of the large number of software apps available today and the wide range of functionality they provide, computing device users often require the ability to search for and access specific software app functionality.

### SUMMARY

In one example, a method includes transmitting, using a searching device, a search query to a search system configured to generate search results in response to a received search query, and selecting, using the searching device, one of a plurality of viewing devices. The method further includes receiving search results from the search system at the one of the plurality of viewing devices in response to transmitting the search query. In this example, each search result indicates a function for a computing device to perform. The method also includes displaying the search results on the one of the plurality of viewing devices, receiving a user selection of one of the search results at the one of the plurality of viewing devices, and transmitting, using the one of the plurality of viewing devices, an indication of the user selection to a performing device. In this example, the performing device is configured to perform the function indicated by the one of the search results in response to receiving the indication.

In another example, a system includes a searching device, a plurality of viewing devices, a performing device, and a search system. The search system is configured to receive a search query from the searching device, and transmit search results that are responsive to the search query. The searching device is configured to select one of the plurality of viewing devices. The one of the plurality of viewing devices is configured to receive the search results from the search system, display the search results to a user, receive a user selection of one of the search results from the user, and transmit an indication of the user selection to the performing device. The performing device is configured to perform a function indicated by the one of the search results in response to receiving the indication.

In another example, a non-transitory computer-readable storage medium includes instructions that cause one or more computing devices to transmit, using a searching device, a search query to a search system configured to generate search results in response to a received search query, and select, using the searching device, one of a plurality of viewing devices. The instructions further cause the one or more computing devices to receive search results from the search system at the one of the plurality of viewing devices in response to transmitting the search query. In this example, each search result indicates a function for a computing device to perform. The instructions also cause the one or more computing devices to display the search results on the one of the plurality of viewing devices, receive a user selection of one of the search results at the one of the plurality of viewing devices, and transmit, using the one of the plurality of viewing devices, an indication of the user selection to a performing device. In this example, the performing device is configured to perform the function indicated by the one of the search results in response to receiving the indication.

### BRIEF DESCRIPTION OF DRAWINGS

The details of one or more examples are set forth in the accompanying drawings and the description below. Other features, objects, and advantages will be apparent from the description and drawings, and from the claims.

FIG. 1 illustrates an example environment that includes a searching device, multiple viewing devices, one or more performing devices, and a search system.

FIG. 2 is a flow diagram that illustrates an example method for performing a search and selecting a viewing device to view results of the search using a searching device.

FIG. 3 is a functional block diagram of an example search module of a search system.

FIG. 4 illustrates an example function record of a search system.

FIGS. 5A-6D illustrate example graphical user interfaces (GUIs) that may be generated on a searching device and viewing devices according to the present disclosure.

FIGS. 7A-9C illustrate example GUIs that may be generated on a searching device, a viewing device, and a performing device according to the present disclosure.

FIGS. 10A-11B illustrate example arrangements of a searching device and multiple viewing devices in communication with a search system.

FIGS. 12A-12B illustrate example arrangements of a searching device, multiple viewing devices, and an intermediate device in communication with a search system.

FIG. 13 is a flow diagram that illustrates an example method for performing a search for function records based on a received search query.

FIGS. 14-16 are flow diagrams that illustrate example methods describing operation of a searching device, a viewing device, and a performing device, respectively.

FIG. 17 is a functional block diagram of an example searching device and an example viewing device in communication with a search system.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of this disclosure.

The present disclosure generally relates to the field of search, and, more particularly, to techniques for generating, displaying, and accessing search results on different computing devices. Specifically, the techniques of this disclosure are directed to performing a search for software applications (apps) using a single user device (e.g., a “searching device”), viewing search results generated as part of the search using any one of multiple different user devices (e.g., “one of a plurality of viewing devices”), and performing functions indicated by the search results using another user device (e.g., “a performing device”). In some examples, the functions indicated by the search results are performed by the user device used to perform the search (e.g., the searching device), the user device used to view the search results (e.g., the one of the plurality of viewing devices), or another user device. According to the techniques disclosed herein, the searching device may transmit a search query to a search system configured to generate search results in response to a received search query. For example, the searching device may receive the search query from a user of the searching device. The searching device may further select one of a plurality of viewing devices. For example, as described in greater detail below, the searching device may select the one of the plurality of viewing devices based on any of a user input received from the user, and location, availability, compatibility, connectivity, historical connectivity, and previous selection data associated with the selected viewing device. Subsequently, the selected viewing device may receive search results from the search system in response to the transmitted search query (i.e., in response to the searching device transmitting the search query to the search system). In this example, each search result may indicate a function for a computing device (e.g., the performing device) to perform. For instance, each search result may include an access mechanism (AM) that, upon being received by a computing device, causes the device to set a software app included on the device into a particular app state. The selected viewing device may display the received search results to the user. The selected viewing device may further receive a user selection of one of the displayed search results from the user. The selected viewing device may also transmit an indication of the user selection to a performing device. In this example, the performing device may be configured to perform the function indicated by the one of the displayed search results in response to receiving the indication. For example, the performing device may be configured to set a software app included on the device into a particular app state using an AM included in the one of the displayed search results, as described above.

A software app, as described herein, may refer to computer software that causes a computing device to perform a task. In some examples, a software app is referred to as a “program.” Example apps include, but are not limited to, word processing apps, spreadsheet apps, messaging apps, media streaming apps, social networking apps, and games. Apps can be executed on a variety of different computing devices. For example, apps can be executed on mobile computing devices, such as smart phones, tablets, and wearable computing devices (e.g., headsets and/or watches, such as so-called “smart watches”). Apps can also be executed on other types of computing devices having other form factors, such as laptop computers, desktop computers, computing devices that are installed in vehicles (e.g., so-called “vehicle navigation systems”), or other consumer electronic devices. In some examples, apps are installed on a computing device prior to a user purchasing the device. In other examples, the user may download and install apps on the computing device after purchasing the device.

The functionality of an app may be accessed on the computing device on which the app is installed. Additionally, or alternatively, the functionality of an app may be accessed via a remote computing device. In some examples, all of an app's functionality is included on the computing device on which the app is installed. These apps may function without communication with other computing devices (e.g., via the Internet). In other examples, an app installed on a computing device may access information from other remote computing devices during operation. For example, a weather app installed on a computing device may access the latest weather information via the Internet and display the accessed weather information to the user through the installed weather app. In still other examples, an app (e.g., a web-based app) may be partially executed by the user's computing device and partially executed by a remote computing device. For example, a web-based app may be executed, at least in part, by a web server and accessed by a web browser of the user's computing device. Example web-based apps may include web-based email, online auction sites, and online retail sites.

As explained above, the present disclosure is directed to techniques for generating search results on a single user computing device, and viewing the search results on any of multiple different user computing devices. In some examples described herein, a user enters a search query into a first computing device (e.g., a smart watch) that then causes a second computing device (e.g., a smart phone, or tablet) to display search results that are responsive to the search query. In some examples, the user and/or the first computing device selects the second computing device from among multiple different computing devices. In some scenarios, the user may be in proximity to both the first and second computing devices. For example, the first computing device may be a wearable computing device (e.g., a smart watch on the user's wrist). In this example, the second computing device may be a mobile computing device (e.g., a smart phone in the user's pocket, or a tablet in the user's palm), or another type of computing device located in proximity to the user (e.g., a vehicle navigation system installed in the user's vehicle, or a television or personal computer present in the user's home). In other examples, the first computing device may be a mobile computing device, such as a smart phone, or a tablet, and the second computing device may be another computing device, such as a smart watch, a vehicle navigation system, a television, or a personal computer.

According to the techniques disclosed herein, a user enters a search query into a first computing device. The first computing device, which receives the search query, may be referred to herein as a “searching device.” The searching device transmits the search query to a search system. In one example, the searching device may transmit the search query to the search system via another user computing device (e.g., a “viewing device,” a “performing device,” or another intermediate computing device, which are described below) to which the searching device is tethered. The searching device being tethered to another user computing device, as described herein, may refer to the searching device being communicatively coupled to the other user computing device using a short-range wired and/or wireless communication interface or connection, such as, e.g., USB, Bluetooth, Ethernet (e.g., LAN), and/or Wi-Fi (e.g., wireless LAN (WLAN)). In this example, the other user computing device may then transmit the search query received from the searching device to the search system via the Internet. In another example, the searching device may not be tethered to another user computing device, but instead the searching device may be configured to connect to the search system directly via the Internet (e.g., via a cellular network, Wi-Fi, and/or another wireless technology) and transmit the search query to the search system. The searching device selects one of a plurality of other computing devices, which may be be referred to herein as “viewing devices,” to receive search results that are responsive to the search query from the search system, and display the search results to the user. The search system generates the search results in response to receiving the search query from the searching device, and transmits the generated search results to the selected viewing device. The selected viewing device displays the search results to the user. A search result that is displayed to the user in this manner may be referred to herein as a “displayed result.”

The user can select one of the displayed results on the selected viewing device. A displayed result that is selected by the user in this manner may be referred to herein as a “selected result.” In response to the user selecting the displayed result, the selected viewing device can transmit an indication of the user's selection (i.e., an indication of a selected result) to another computing device, which may be referred to herein as a “performing device.” The performing device may be configured to perform one or more operations, or functions, according to the selected result in response to receiving the indication. For example, the performing device may launch a native app (e.g., an app that is installed and executed on a user device 102) included on the performing device and set the app into an app state indicated by the selected result. The user can view and interact with the app state on the performing device. In another example, instead of launching a native app and setting the app into an app state, the performing device can show an expanded view of the selected result (e.g., a view that includes more content, detail, and/or user input/output options compared to the result). Displaying the expanded view of the selected result may be beneficial when the user desires to view the result on a larger screen than that provided by the selected viewing device (e.g., a smart watch, or a smart phone).

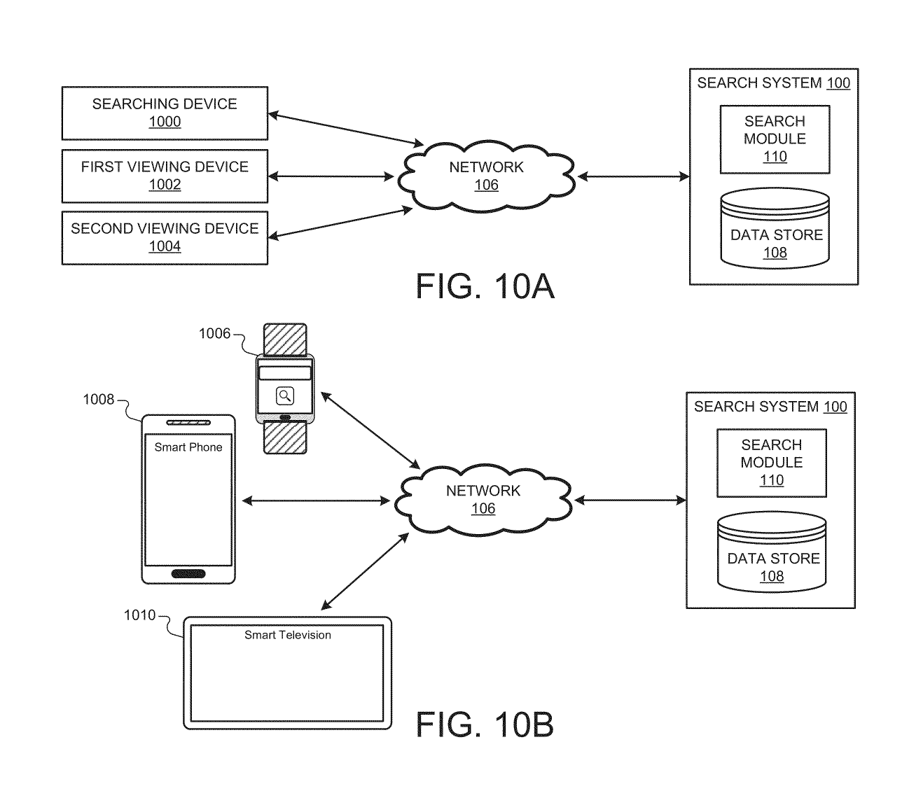

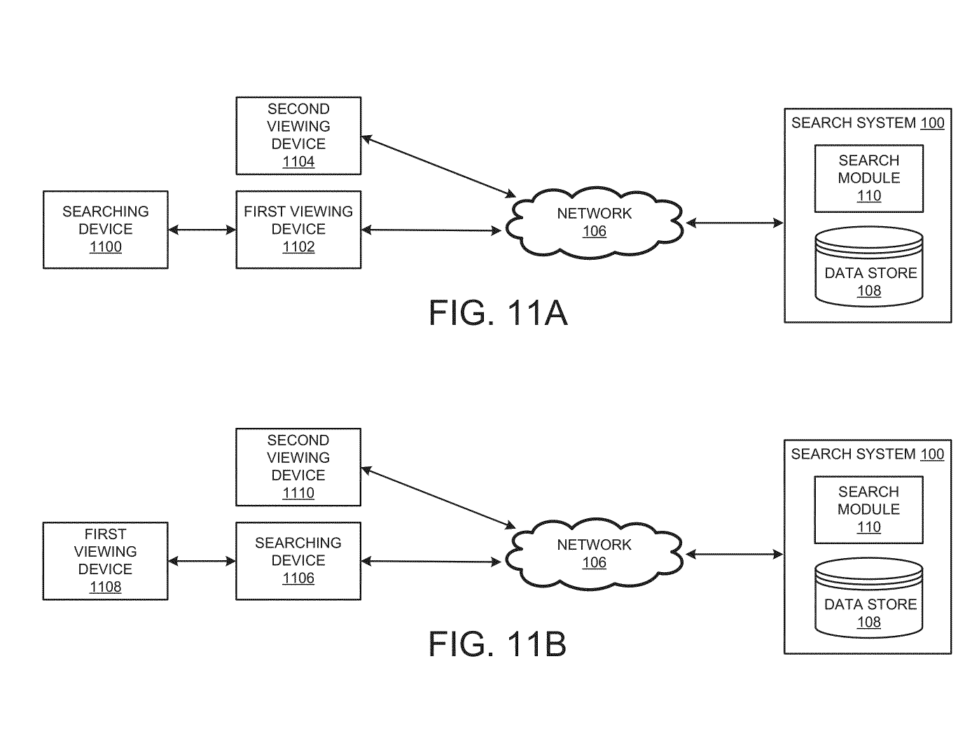

The techniques of the present disclosure may be implemented for various different network topology arrangements of the searching device, multiple viewing devices, one or more performing devices, and the search system. In some examples (e.g., FIG. 11A), the searching device is tethered to a viewing device such that the searching device communicates with the search system via the viewing device. For example, the searching device may communicate with the viewing device via a short-range wired connection (e.g., USB) or a short-range wireless connection (e.g., Bluetooth), and the viewing device may communicate with the search system via the Internet (e.g., via a cellular network, or a home router). In other examples (e.g., FIG. 10A), the searching device and the multiple viewing devices may independently communicate with the search system. For example, the searching device and the viewing devices may have separate wireless Internet connections that each enable communication with the search system via the Internet. The separate wireless connections may be wireless connections to the same wireless router at home. The separate wireless connections may also be different types of wireless connections, depending on the connectivity options available on the searching device and the viewing devices. For example, the searching device may be configured to communicate with the Internet via a cellular radio or network connection, and one or more of the viewing devices may be configured to communicate with the Internet via a Wi-Fi connection.

While in some examples, a searching device of the present disclosure selects one viewing device to display search results, in other examples, the searching device may select each of multiple different viewing devices to display search results. In these examples, each of the multiple viewing devices can display search results (e.g., different portions of search results received at a given point in time, or search results received at different points in time).

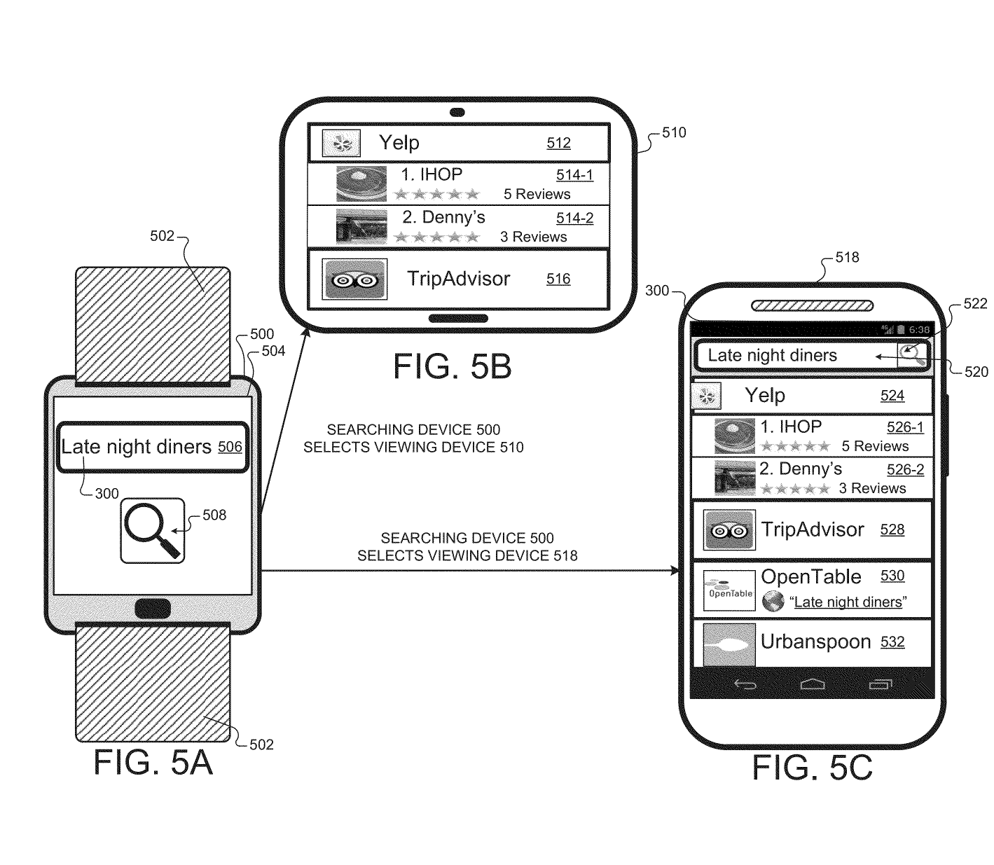

The search results generated by the search system include one or more result objects. A single result object may refer to data associated with a single search result (e.g., a single displayed result, or a single selected result). The search system transmits the result objects to the viewing device. The viewing device generates one or more displayed results using the result objects. For example, the viewing device may generate one displayed result for each result object received from the search system. In some examples, the viewing device displays only a single displayed result at a time. For example, if the viewing device has a relatively small screen size (e.g., as in the case of a wrist watch computing device, such as a smart watch), then it may be beneficial to fill the entire display of the viewing device with a single displayed result. In this example, a user may use a gesture (e.g., a swipe) on a touchscreen of the viewing device, or interact with a physical button of the viewing device, to show another single displayed result, such as a next displayed result in an order of the displayed results. While in some examples, the viewing device is configured to show only a single displayed result, in other examples, the viewing device may be configured to display multiple different displayed results at a time (e.g., as shown in FIGS. 5B, 5C, 6C, 6D, 7B, 8B, 9B, and 17). For example, the viewing device may display a list of multiple displayed results, e.g., according to the order of the displayed results. The user may select one of the displayed results from the list. Additionally, the user may interact with the list to scroll through the list using a gesture (e.g., a swipe) on a touchscreen of the viewing device, or interact with a physical button of the viewing device.

A result object may include various different data described herein. A result object may include one or more AMs for accessing functionality of an app. For example, a result object may include on or more app AMs (AAMs). Additionally, or alternatively, a result object may include a web AM (WAM). In some examples, a result object includes an app download address (ADA). AAMs, WAMs, and ADAs are described below. A result object may also include additional data used by the viewing device to generate a displayed result. For example, a result object can include text and/or images that may be displayed to a user in a displayed result. The text and/or images may indicate the operations, or function that may be performed in response to selection of the displayed result. For example, if the displayed result is for a song in a music playing app, the text and/or images may identify the app that may be launched by a performing device and the song that may be played by the app when the user selects the result. Example displayed results are shown in FIGS. 5B, 5C, 6C, 6D, 7B, 8B, 9B, and 17.

A result object may also include data (e.g., instructions) that defines how to render a displayed result. The viewing device can render a displayed result based on such data included in a result object corresponding to the result. The result object can include data that defines graphical aspects (e.g., formatting and arrangement) of the displayed result, such as the layout of text, images, and animations in the result. In some examples, the data that defines how to render the displayed result is device-specific data that indicates different formatting and arrangement depending on the display capabilities of the viewing device. For example, if the viewing device has a relatively smaller display (e.g., a smart watch display), the formatting and arrangement data may indicate how to render the displayed result on the smaller display (e.g., as one displayed result per screen of the display). If the viewing device has a relatively larger display, the formatting and arrangement data may indicate how to render the displayed result on the larger display (e.g., as an entry in a list of multiple displayed results). In other examples, the viewing device may receive a result object that does not include formatting and arrangement data. In these examples, the viewing device (e.g., a native app, a web browser app, and/or an operating system (OS) of the viewing device) may determine how to format a displayed result corresponding to the received result object.

A result object can include data that defines additional user interface elements, such as user inputs and outputs. Example user inputs may include graphical buttons, text boxes, and (e.g., drop down) menus. Example user outputs may include GUI elements configured to display text and/or graphics to the user. A result object can also include data that defines how to retrieve information from the Internet (e.g., an app server, a web server, and/or the search system). For example, portions of a displayed result generated for a result object received in response to a search query may be populated in real-time after the query is transmitted (i.e., after the object is received and the result is generated). In this example, the result object may include data that instructs the viewing device where to obtain the real-time data (e.g., via a web address). The real-time data may include various different types of data, e.g., weather, ticket availability, stock market, restaurant table availability, and current taxi location data. A result object can also include instructions for performing calculations, e.g., based on a user input. For example, a result object may include data used to render a calculator (e.g., scientific and/or graphing), or a similar mathematical interface, within a displayed result. The data included in a result object may be generated by the search system according to a function record (e.g., as shown in FIG. 4).

A result object can further include data (e.g., instructions) that defines how a viewing device indicates selection of a displayed result to a performing device. In examples where the viewing device is directly connected (e.g., wirelessly via Bluetooth) to the performing device, the viewing device can indicate a selection of a displayed result to the performing device via the direct connection. In examples where the viewing device is not directly connected (e.g., via a wireless or wired connection) to the performing device, the viewing device can indicate a selection of a displayed result to the performing device by transmitting an indication of the selection to the performing device via the Internet, or a local network (e.g., LAN or WLAN).

The indication of the selected result sent from the viewing device to the performing device can include various different types of data. In some examples, the indication includes one or more AMs (e.g., AAM(s), WAM(s), and/or ADA(s)). For example, the viewing device may transmit one or more AAMs of the selected result to the performing device so that the performing device can access a state of a native app installed on the performing device. In this example, the viewing device may transmit an ADA also included in the selected result to the performing device so that the performing device can download and install the native app. In another example, the viewing device may transmit a WAM of the selected result to the performing device so that the performing device can access a web address (e.g., a URL) using a web browser app of the performing device. In some examples, the viewing device does not need to transmit an AM, but instead may indicate to the performing device which search result (e.g., via a rank number) has been selected by the user. In these examples, the performing device may have access to the search results, and thus may already have one or more AMs included in the results stored in the device. This may allow the viewing device to simply indicate which search result has been selected by the user without explicitly transmitting an AM for the result. In still another example, the viewing device may transmit a function identifier (ID) to the performing device, upon which the performing device may use the function ID to access a function record used by the search system to generate the selected result. The performing device may then select one or more AMs associated with the search result from the identified function record.

The indication transmitted by the viewing device to the performing device may indicate one or more operations for the performing device to perform. As described above, the indication may either include an AM (e.g., an AAM, a WAM, and/or an ADA), or specify a location from which the AM can be retrieved. For example, an AAM may be a string including a reference to a native app and indicating one or more operations for the performing device (e.g., the app) to perform. A WAM may include a resource identifier (e.g., a URL) that directs a web browser app of the performing device to a web resource. An ADA may include data used by the performing device to download a native app referenced by an AAM (e.g., from a digital distribution platform). AAMs, WAMs, and ADAs are described in greater detail hereinafter.

Transmission of the indication of the selected result from the viewing device to the performing device may involve a variety of different network paths. In examples where the viewing device is directly connected to the performing device via a wired connection (e.g., USB) or a wireless connection (e.g., a short-range wireless connection, such as Bluetooth), the viewing device may transmit the indication to the performing device via the direct connection (e.g., via the wired connection or short-range wireless connection). In examples where the viewing device is not directly connected to the performing device, the viewing device may transmit the indication to the performing device via a network. As one example, the viewing device may transmit the indication to the performing device via the Internet. As another example, the viewing device may transmit the indication to the performing device through a more local network (e.g., a home network, such as a LAN or a WLAN). As still another example, the viewing device may transmit the indication to the search system and the search system may then transmit the indication to the performing device.

In examples where the viewing device indicates a function ID to the performing device, the viewing device may transmit the function ID to the performing device, which may then retrieve one or more AMs included in the corresponding function record from the search system. In another example, the viewing device may transmit the function ID to the performing device via the Internet, or a more short-range network, and the performing device may send the function ID to the search system to retrieve the AMs from the search system. In still another example, the viewing device may transmit the function ID to the search system, upon which the search system may transmit the AMs to the performing device.

The viewing device generates displayed results based on data included in result objects received by the device from the search system. For example, the viewing device may generate a single displayed result based on data included in a single result object received by the device. In some examples, the viewing device generates multiple displayed results on the display of the device at one time (e.g., as shown in FIGS. 5B, 5C, 6C, 6D, 7B, 8B, 9B, and 17, the user views multiple different displayed results on the display of the device at one time).

In some examples, the viewing device generates only a single displayed result at one time. For example, the single displayed result may occupy an entire viewable area of the display of the viewing device. Put another way, the viewing device may be configured to display only one displayed result at a time. The viewing device may be configured to display only a single displayed result in scenarios where the device has limited display area. For example, if the viewing device is a wearable computing device (e.g., a wrist watch computing device, such as a smart watch), the display of the device may be limited in size (e.g., have a screen diagonal size of 2 inches or less). In these examples, generating a single displayed result may allow the user to fully view the result and easily assess whether the result is desirable for the user to select.

The manner in which a user selects a displayed result may vary depending on the format of the result. In some examples, a user selects a displayed result by touching (e.g., tapping) a portion of the result. For example, the user may select the displayed result by touching the portion of a display of the viewing device including the result. In examples where the viewing device displays only a single search result, the user may select the single displayed result by touching anywhere on the display. In still other examples, the displayed result may include regions that are indicated as places where the user may tap to select the result. For example, the displayed result may include a button graphic (e.g., the image of pancakes shown in the link 514-1 of FIG. 5B) that indicates where the user can tap to select the result. In some examples, the displayed result includes text and/or images that indicate the action that may be taken when the user interacts with the result. For example, the displayed result may indicate a native app that may be launched on a performing device, a web location that may be accessed using a web browser app of the device, or an expanded view that may be shown on the device.

As described above, the viewing device may transmit an indication of a user's selection of a displayed result (i.e., an indication of a selected result) to a performing device. The manner in which the viewing device determines the performing device may be the same as, or similar to, the manner in which the searching device selects the viewing device, as described above. In some examples, the viewing device automatically selects the performing device. For example, if the viewing device is tethered to the performing device, the viewing device may automatically transmit the indication to the performing device in response to the user's selection of the displayed result. In other examples, the viewing device may prompt the user to select the performing device. For example, after the user selects the displayed result, the viewing device may display indications (e.g., names or descriptions) of one or more different possible performing devices from which the user may select the performing device. The user may then select the performing device from the one or more different possible performing devices. In response to the user's selection of the performing device, the viewing device may transmit the indication to the selected performing device.

In some examples, there are multiple possible performing devices that the user may wish to use to perform a function indicated by the selected result. In some instances, the viewing device may detect the multiple possible performing devices. For example, the viewing device may detect a performing device based on a wired connection (e.g., USB), or a wireless connection (e.g., a Bluetooth connection) with the performing device. In some examples, the viewing device maintains a list of possible performing devices that the user may use (e.g., based on a previous connection to the viewing device). For example, the list may include a mobile device (e.g., a smartphone, or a tablet), a laptop, or a desktop computing device. The viewing device may display one or more of the possible performing devices from the list to the user. In some examples, the viewing device maintains a history of performing devices to which the viewing device has previously transmitted indications of selected results.

In some examples, a performing device is determined by the viewing device and/or the search system based on a relative geo-location of the viewing device and the performing device. For example, the viewing device may determine which computing devices are near (e.g., in the same location, or within a short distance from) the viewing device (e.g., based on geo-location, such as geographic coordinates obtained from a GPS module), and then transmit an indication of a selected result to the performing device(s) that are near the viewing device. In some examples, the search system facilitates the above-described geo-location determination made by the viewing device. For example, the search system may determine the geo-location of the viewing device based on geo-location data received from the device. The search system may also maintain communication with one or more possible performing devices to determine the geo-location of the device(s). For example, the possible performing device(s) may include software that communicates their positions to the search system. Using the geo-location of the viewing device and the possible performing device(s), the search system may determine which of the possible performing device(s) are near the viewing device, and transmit an indication of this determination to the viewing device. Alternatively, the search system may transmit the geo-location of the possible performing device(s) to the viewing device so that the viewing device may make this determination.

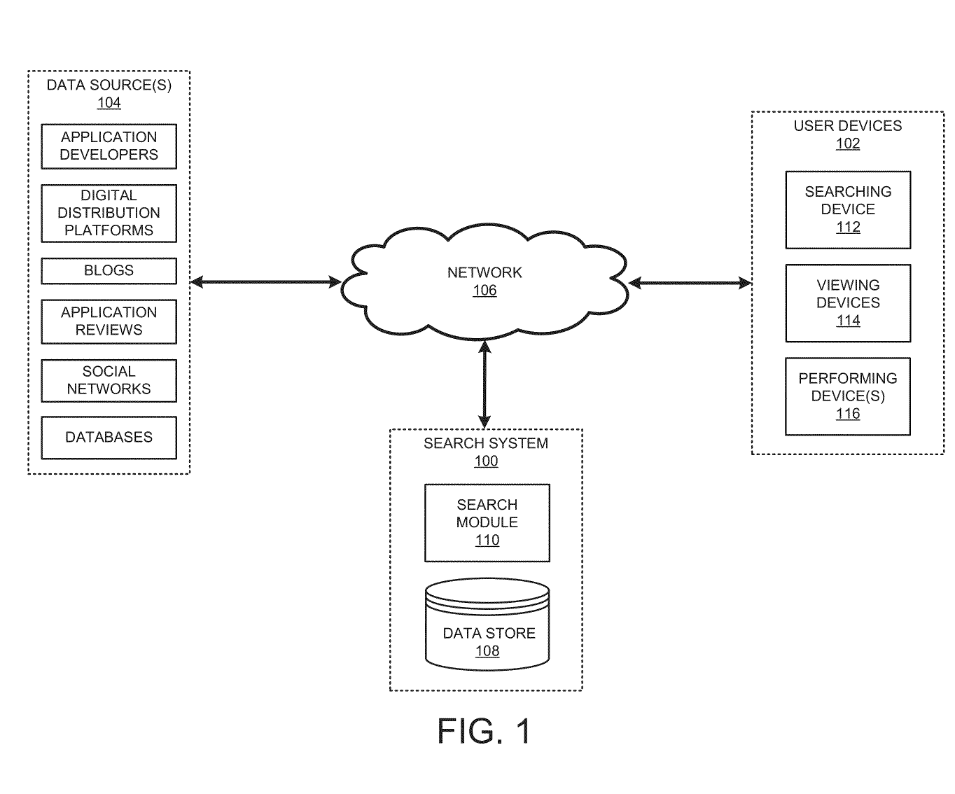

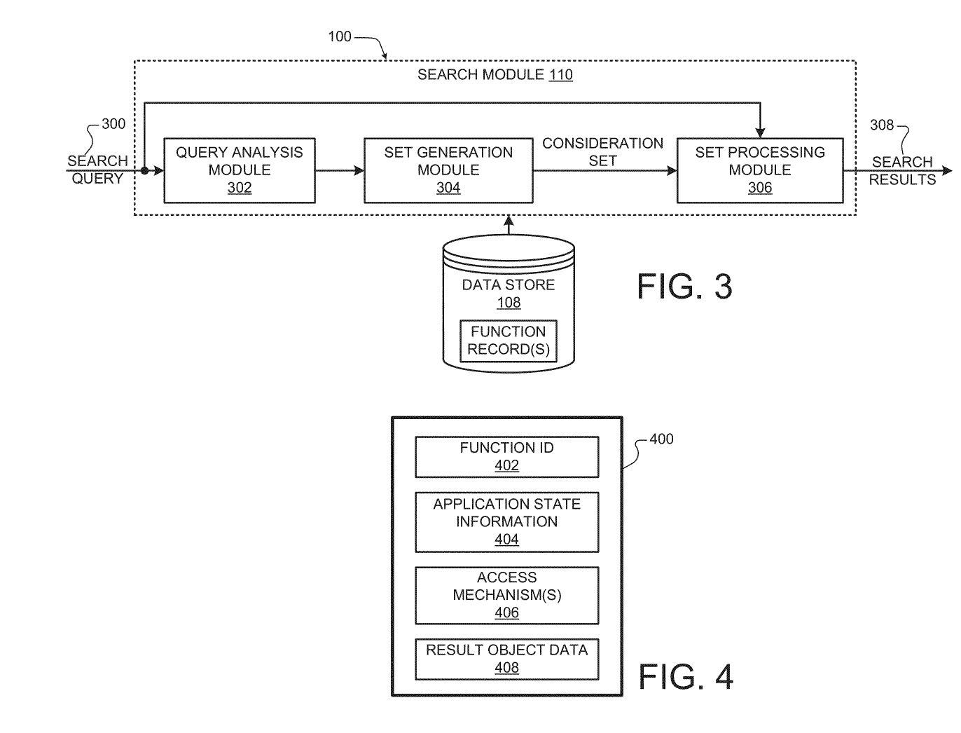

FIG. 1 illustrates an example environment that includes a search system 100, user devices 102, one or more data sources 104, and a network 106. In the example of FIG. 1, the search system 100 includes a data store 108 and a search module 110. Also in this example, the user devices 102 include a searching device 112, multiple viewing devices 114, and one or more performing devices 116. The data source(s) 104 are described in greater detail below with reference to FIG. 3. According to the techniques disclosed herein, a user device 102 (e.g., the searching device 112) receives a search query from a user of the device 102 (e.g., via a user interface of the device 102) and transmits the query to the search system 100. In some examples, the user device 102 includes the search query in a query wrapper. The search system 100 receives the search query from the user device 102 and generates one or more search results (e.g., one or more result objects) in response to receiving the query. The user device 102 selects (e.g., using a user input received from the user, or other considerations) another user device 102 (e.g., one of the viewing devices 114) to view the search results. The search system 100 transmits the search results (e.g., the result objects) to the other user device 102. The other user device 102 receives the search results from the search system 100, displays the results to the user, receives a user selection of one of the results from the user, and transmits an indication of the user selection to yet another user device 102 (e.g., one of the performing device(s) 116). The user device 102 that receives the indication performs a function associated with the selected search result in response to receiving the indication. The search system 100 uses the data store 108 and search module 110 to generate the search results (e.g., the result objects). Example operation of the search system 100, data store 108, and search module 110 is now described.

In some examples, the searching device 112 transmits additional data with the search query. In these examples, the searching device 112 may include the additional data and the search query in a query wrapper. The query wrapper may include the search query and data associated with the query. Examples of the additional data include geo-location data (e.g., data indicating a location of the searching device 112), platform data (e.g., a version of an OS of the device 112, a device type of the device 112, such as a smart watch, a smart phone, or a tablet, and a version of a web browser app of the device 112), an identity of a user of the device 112 (e.g., a username), partner specific data, and other data. The searching device 112 transmits the query wrapper to the search system 100. The search system 100 may use the search query and/or the additional data included in the query wrapper to generate the search results.

In some examples, the searching device 112 transmits the query wrapper to one of the viewing devices 114. This may be the case if the searching device 112 connects to the Internet, thereby connecting to the search system 100, via the viewing device 114. In examples where the viewing device 114 receives the query wrapper from the searching device 112, the viewing device 114 may modify the query wrapper generated by the searching device 112 and transmit the modified query wrapper to the search system 100. For example, the viewing device 114 may add to, remove, or otherwise modify data included in the query wrapper received from the searching device 112. In some examples, the viewing device 114 adds data indicating information related to the device 114 to the query wrapper. For example, the viewing device 114 may add data to the query wrapper, such as geo-location data (e.g., indicating a location of the device 114), platform data (e.g., indicating a version of an OS of the device 114, a device type of the device 114, and a version of a web browser app of the device 114), and an identity of a user of the device 114 (e.g., a username). In these examples, the query wrapper received by the search system 100 from the viewing device 114 may include data related to both the searching device 112 and the viewing device 114. Accordingly, the search system 100 may determine specific information for each of the computing devices, such as an OS of each device, a geo-location of each device, and a device type of each device. For example, the search system 100 may determine whether the searching device 112 and the viewing device 114 include a wearable computing device (e.g., a smart watch, a head-mounted display, such as so-called “smart glasses,” or so-called “smart contact lenses”), a smart phone, or a tablet, laptop, or desktop computing device. As described herein, in some examples, the search system 100 formats the search results (e.g., the result objects) transmitted by the system 100 to the viewing device 114 based on the device type, or any other properties, of the searching device 112 and/or the viewing device 114 indicated by the data included in the query wrapper. As one example, the search system 100 may use a device type of the viewing device 114 indicated by the query wrapper to generate formatting data to be included in the search results. The formatting data may define how the search results may be displayed on the viewing device 112, as described herein. As another example, in cases where the searching device 112 or the viewing device 114 is used as a performing device 116, the search system 100 may use a device type of the respective device(s) 112, 114 indicated by the query wrapper to include one or more AMs (e.g., an AAM, a WAM, and/or an ADA) that are compatible with the respective device(s) 112, 114 in the search results, as also described herein.

The search system 100 includes the data store 108, which the system 100 uses to generate the search results. The data store 108 includes one or more different function records (e.g., the function record 400 of FIG. 4). Each function record may include data related to a function of a native app and/or a state of the app resulting from performance of the function. As described herein, a function record may include a function ID, app state information (ASI), one or more AMs, and other result object data described above. The AMs may include one or more AAMs, WAMs, and/or ADAs. In some examples, the function records described herein includes additional data. In other examples, the function records may include less data than that illustrated in FIG. 4. As one example, a function record may include an AAM, but not include a WAM. As another example, a function record may include a WAM, but not include an AAM. In some examples, a function record includes multiple different AAMs.

An AAM may be a string that references a native app and indicates one or more operations for a user device 102 (e.g., one of the performing device(s) 116) to perform. In response to selection of the AAM by a user on one of the viewing devices 114, one of the performing device(s) 116 may launch the native app referenced by the AAM and perform the one or more operations indicated by the AAM. For example, the performing device 116 may perform the operations to set the native app into a particular app state of the app.

Native apps can perform a variety of different functions for a user. As one example, a restaurant reservation app can make reservations for restaurants. As another example, an Internet media player app can stream media (e.g., a song, or a movie) from the Internet. In some examples, a single native app can perform more than one function. As one example, a restaurant reservation app may allow a user to retrieve information about a restaurant, read user reviews for the restaurant, and view a menu of the restaurant. As another example, an Internet media player app may allow a user to perform searches for digital media, purchase digital media, stream digital media, and generate digital media playlists.

An AAM includes data, which a user device 102 (e.g., one of the performing device(s) 116) can use to access functionality provided by a native app. For example, an AAM can include data that causes a performing device 116 to launch a native app installed on the device 116 and perform a function associated with the app. Performance of a function according to an AAM may set a native app into a specified app state. Accordingly, the process of launching a native app and performing a function according to an AAM may be referred to herein as launching the app and setting the app into an app state specified by the AAM. In one example, an AAM for a restaurant reservation app can include data that causes a performing device 116 to launch the app and make a reservation at a restaurant or indicate available reservation times. In this example, the restaurant reservation app may be set in an app state that displays reservation information to a user, such as a reservation time, a description of the restaurant, and user reviews. In another example, an AAM for an Internet media player app can include data that causes a performing device 116 to launch the app and stream media from the Internet. In this example, the app may be set in an app state that displays information regarding the media (e.g., music) being streamed, such as a song name, an artist name, or an album name.

AAMs may have various different formats and content. The format and content of an AAM may depend on the native app with which the AAM is associated and the operations that are performed by the app in response to selection of the AAM. For example, an AAM for an Internet music player app may differ from an AAM for a shopping app. The AAM for the Internet music player app may reference musical artists, songs, and albums. The AAM for the Internet music player app may also reference operations, such as randomizing a list of songs and playing a song or album. The AAM for the shopping app may reference different products that are for sale. The AAM for the shopping app may also reference one or more operations, such as adding products to a shopping cart and proceeding to a checkout.

A user may select a displayed result on one of the viewing devices 114 to cause one of the performing device(s) 116 to launch a native app identified by the result and perform one or more operations according to an AAM associated with the result. Put another way, when the user selects the displayed result on the viewing device 114, the performing device 116 launches the native app installed on the device 116 and sets the app into an app state defined by the AAM associated with the result. In general, a state of a native app may refer to one or more operations and/or a resulting outcome of the app performing the operations in response to a user selection of a displayed result. A state of a native app may also be referred to herein as an “app state.”

An app state of a native app specified by an AAM may depend on the functionality provided by the app. For example, if a native app is configured to retrieve and display information from an external resource (e.g., a web server) via the Internet, the app can be set into a state in which the app retrieves information from the external source via the Internet and displays the information to the user. In another example, if a native app is configured to play media from an external resource via the Internet (e.g., music and/or video), the app can be set into a state in which the app is playing a song or a movie from the external resource via the Internet. In another example, if a native app is configured to make restaurant reservations, the app can be set into a state in which the app displays available restaurant reservations to the user.

An AAM included in a function record includes data that causes a user device 102 (e.g., one of the performing device(s) 116) to launch a native app and perform a function associated with the app. For example, an AAM included in a function record may be a string that includes a reference to a native app and indicates one or more operations for a performing device 116 (e.g., the app) to perform. An AAM may include an app resource identifier (ARI) and/or one or more operations for a performing device 116 to perform. The ARI is a string having an app-specific scheme, in some examples. The ARI may include a reference to a native app and indicate one or more operations for a performing device 116 (e.g., the app installed on the performing device 116) to perform. For example, the ARI may include a reference to the native app, a domain name, and a path to be used by the app to retrieve and display information to the user. An example ARI is described with reference to the function record 400 of FIG. 4.

In some examples, an AAM includes operations for a performing device 116 to perform in addition to one or more operations indicated by an ARI of the AAM. For example, a native app installed on a performing device 116 and/or an OS of the device 116 may perform these additional operations. In some examples, the operations are included in a script. Examples of the operations include launching a native app, creating and sending a search request to an app server, setting a current geographic location in the app, making a restaurant reservation, sending a text message, and adding an appointment to a calendar.

In some examples, an AAM does not include an ARI. Instead, the AAM can include one or more operations that reference a native app and indicate one or more operations for a performing device 116 to perform. The one or more operations may include instructions for the native app and/or an OS of the performing device 116. In response to selection of the AAM, the performing device 116 may perform the operations included in the AAM.

A function ID included in a function record may be a string that uniquely identifies the record among other function records included in the data store 108. In some examples, the function ID describes a function and/or an app state in human-readable form. For example, the function ID may be a human-readable string that describes a function performed according to an AAM and/or an app state resulting from performance of the function according to the AAM. In a more specific example, a function ID of a function record that describes a song within an Internet music player app may include a name of the app along with a name of the song that may be played when the app is set into an app state defined by an AAM included in the record. An example function ID is described with reference to the function record 400 of FIG. 4.

A function record also includes ASI. The ASI includes data that describes an app state into which a native app is set according to an AAM included in the function record. In some examples, the ASI includes data that describes a function performed according to the AAM. The ASI can include text, numbers, and symbols that describe the app state or function. The types of data included in the ASI may depend on the type of information associated with the app state and the functionality specified by the AAM. In some examples, the ASI includes data that is presented to the user when the native app is in the app state defined by the AAM. For example, a function record associated with a shopping app can include ASI that describes products (e.g., names and prices) that are shown when the app is set into an app state defined by an AAM of the record. As another example, a function record associated with a music player app can include ASI that describes a song (e.g., name and artist) that is played when the app is set into an app state defined by an AAM of the record.

The ASI included in a function record may be generated in a variety of different ways. In one example, data to be included in the ASI may be retrieved via partnerships with database owners and developers of native apps. For example, the data may be automatically retrieved from online databases that include data related to movies, television programs, music, and restaurants. In some examples, some or all of the data included in the ASI is manually-generated by a human operator. The data included in the ASI may be updated over time so that the search system 100 provides up-to-date search results.

The search system 100 generates one or more search results including one or more result objects using the function records included in the data store 108. Initially, the search system 100 may analyze a search query received from the searching device 112. The search system 100 then identifies one or more function records included in the data store 108 based on the (e.g., analyzed) search query. The identified function records may be referred to herein as a “consideration set.” For example, the search system 100 may identify the consideration set based on one or more matches (e.g., text matches) between one or more terms of the search query and one or more terms of the ASI included in the function records of the consideration set.

The search system 100 processes (e.g., scores) the consideration set. For example, the search system 100 may determine how well the function records of the consideration set match the search query. In a specific example, the search system 100 may determine how well terms of the search query match terms of the ASI of the identified function records of the consideration set using Lucene® information retrieval software developed by the Apache Software Foundation. The search system 100 may then select one or more (e.g., highest-scoring) function records that best match the search query from the consideration set to generate the result objects. The search system 100 then generates the result objects based on the (e.g., selected) function records of the consideration set. For example, the search system 100 may select AMs (e.g., AAMs, WAMs, and ADAs) from the function records to include in the result objects. The search system 100 then transmits the result objects to one of the viewing device(s) 114 selected by the searching device 112 that generated the search query. The selected viewing device 114 receives the search results including the result objects, displays the results to a user, detects a user selection of one of the displayed results, and transmits an indication of the user selection to one of the performing device(s) 116. The performing device 116 performs a function associated with the selected result in response to receiving the indication, as described herein.

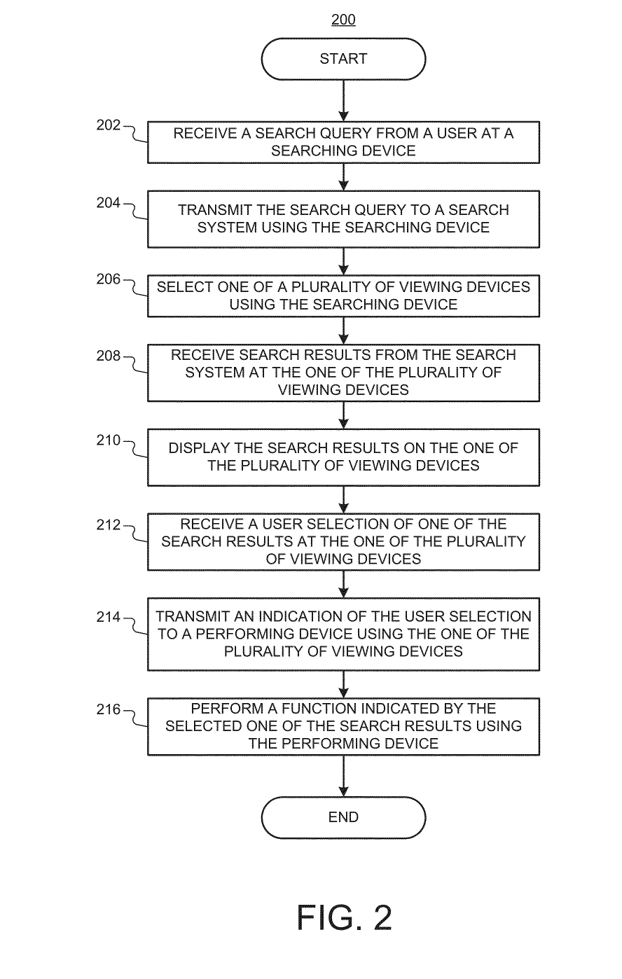

FIG. 2 is a flow diagram that illustrates an example method 200 for performing a search using a searching device 112 and selecting a separate viewing device 114 to view results of the search. In block 202, the searching device 112 receives a search query from a user of the device 112. The search query may include text, numbers, and/or symbols (e.g., punctuation) entered into the searching device 112 by the user. For example, the user may have entered the search query into a search field (e.g., box) of a search app executing on the searching device 112. The user may have entered the search query using a touchscreen keypad, a mechanical keypad, and/or via speech recognition. As described herein, in some examples, the search app is a native app dedicated to search, or a more general app, such as a web browser app. In general, a search query may be a request for information retrieval (e.g., search results) from the search system 100. For example, a search query may be directed to retrieving one or more displayed results that indicate native app functionality, or app states, in examples where the search system 100 is configured to generate one or more AAMs as search results. A search query directed to retrieving one or more search results related to native apps may indicate a user's desire to access functionality of one or more native apps described by the query. In any case, in block 204, the searching device 112 transmits the search query to the search system 100. The search system 100 generates search results that are responsive to (i.e., based on) the search query and transmits the search results, as described in greater detail below.

In block 206, the searching device 112 selects one of a plurality of viewing devices 114. For example, as described herein, the searching device 112 may select the one of the plurality of viewing devices 114 based on any of a user input, and location, availability, compatibility, connectivity, historical connectivity, and previous selection data associated with the selected viewing device 114, as well as any number of other considerations. In some examples, the searching device 112 detects, or receives, the user's selection of the one of the plurality of viewing devices 114 (e.g., after displaying an indication of each of one or more of the plurality of viewing devices 114 to the user on the device 112). In a specific example, the user may touch an indication (e.g., a GUI element) of the one of the plurality of viewing devices 114 (e.g., a viewing device 114 located near the user) displayed to the user on the searching device 112 to the select the device 114. The searching device 112 may then select the viewing device 114 selected by the user. In other examples, the user may provide an indication (e.g., a list) of one or more potential viewing devices from which the searching device 112 may select a viewing device 114 to the device 112 (e.g., prior to providing the search query to the device 112). The searching device 112 may then select the one of the plurality of viewing devices 114 using the indication (e.g., from the list). In still other examples, the user may provide an indication (e.g., a list) of one or more viewing devices that the searching device 112 may not select as a viewing device 114 (e.g., even though the viewing devices may be connected to the device 112). In some examples, the searching device 112 determines (e.g., compile a list of) one or more potential viewing devices from which the device 112 may select a viewing device 114 based on the user's previous selection of the potential viewing devices at the device 112 and select one of the potential viewing devices as the viewing device 114.

In some examples, the searching device 112 determines, or receives from another computing device, location data that indicates a location of each of one or more of the plurality of viewing devices 114 (e.g., geographic coordinate data obtained from a GPS module of each device 114). The searching device 112 may then identify one of the plurality of viewing devices 114 that is located most proximate to the device 112 using the location data and select the device 114. In still other examples, the searching device 112 may determine, or receive from another computing device, availability data that indicates whether each of one or more of the plurality of viewing devices 114 is available to display the search results. For example, the availability data may indicate whether the searching device 112, or another computing device, has recently selected each such viewing device 114 to display other search results, thereby rendering the device 114 unavailable to display the search results. The searching device 112 may then select one of the plurality of viewing devices 114 that is available to display the search results. In still other examples, the searching device 112 may determine, or receive from another computing device, compatibility data that indicates whether each of one or more of the plurality of viewing devices 114 is capable of displaying the search results (e.g., includes the required display technology, resolution, and/or size). In examples where a viewing device 114 is used as a performing device 116, the compatibility data may indicate whether the device 114 is able to process an AM (e.g., an AAM, or a WAM) that specifies a function indicated by one of the search results. For example, the viewing device 114 may be compatible with the AM if the device 114 includes an OS, a native app, and/or a web browser app that can accept and process the AM. In any case, the searching device 112 may select one of the plurality of viewing devices 114 that is capable of displaying the search results and/or processing an AM included in the results. In still other examples, the searching device 112 may determine, or receive from another computing device, connectivity data and/or historical connectivity data that indicate whether each of one or more of the plurality of viewing devices 114 is connected, or has been previously connected, respectively, to the device 112 via a communication interface. The searching device 112 may then select one of the plurality of viewing devices 114 that is connected, or has been previously connected, to the device 112 via a communication interface. In these examples, current and/or previous connectivity of a viewing device 114 to the searching device 112 may indicate one or more of user preference to select the viewing device 114 to display search results, proximity of the viewing device 114 to the searching device 112, availability of the viewing device 114 to display the results, and/or capability of the viewing device 114 to display the results and/or process an AM included in the results, in a similar manner as described above. In other examples, the searching device 112 may determine, or receive from another computing device, previous selection data that indicates one or more of whether and how frequently each of one or more of the plurality of viewing devices 114 has been previously selected by the device 112. The searching device 112 may then select one of the plurality of viewing devices 114 that has been previously (e.g., most frequently) selected by the device 112. The previous selection data of a viewing device 114 may also indicate any of user preference to select the viewing device 114 to display search results, proximity of the viewing device 114 to the searching device 112, availability of the viewing device 114 to display the results, and/or capability of the viewing device 114 to display the results and/or process an AM included in the results, as also described above. In some examples, the search system 100 facilitates any of the viewing device 114 selection techniques described above with reference to the searching device 112.

The searching device 112 may be any computing device that is capable of providing search queries to the search system 100. For example, the searching device 112 may be, but is not limited to, a wearable computing device (e.g., a smart watch), a smart phone, or a tablet, laptop, or desktop computing device. The searching device 112 may also be another computing device having another form factor, such as a computing device included in a vehicle (e.g., a vehicle navigation system), a gaming computing device, a television (e.g., a smart television), or another computing device (e.g., a networked home automation device, or a home appliance).

The searching device 112 may use a variety of different operating systems. In an example where the searching device 112 is a mobile device, the device 112 may run an OS including, but not limited to, ANDROID® developed by Google Inc., IOS® developed by Apple Inc., WINDOWS PHONE® developed by Microsoft Corporation, or TIZEN® developed by the Linux Foundation. In an example where the searching device 112 is a laptop or desktop computing device, the device 112 may run an OS including, but not limited to, MICROSOFT WINDOWS® developed by Microsoft Corporation, MAC OS® developed by Apple Inc., or LINUX® (LINUX® is the registered trademark of Linus Torvalds in the U.S. and other countries). The searching device 112 may also access the search system 100 while running operating systems other than those operating systems described above.

The searching device 112 may communicate with the search system 100 via a computer network (e.g., the network 106), such as the Internet. In some examples, the searching device 112 communicates with the search system 100 using a native app installed on the device 112 (e.g., a search app). In general, the searching device 112 may communicate with the search system 100 using any app that can transmit search queries to the system 100. In some examples, the searching device 112 executes an app that is dedicated to interfacing with the search system 100, such as an app dedicated to searches (e.g., a search app). In other examples, the searching device 112 may communicate with the search system 100 using a more general app, such as a web browser app. The app run by the searching device 112 to communicate with the search system 100 may display a search field (e.g., the search field 506 shown in FIG. 5A) within a GUI into which the user may enter search queries. The user may enter a search query using a touchscreen or physical keyboard, a speech-to-text program, or another form of user input. Accordingly, as described herein, the searching device 112 may include at least one of an OS, a search app, a web browser app, and one or more native apps that are configured to communicate with the user and the search system 100, receive search queries from the user, transmit the queries to the system 100, and select the viewing device 114.

In block 208, the selected one of the plurality of viewing devices 114 receives the search results (e.g., result objects) from the search system 100. For example, the searching device 112 may transmit viewing device selection data to the search system 100, indicating that the search system 100 is to transmit the search results to the selected viewing device 114. Alternatively, the searching device 112 may receive the search results from the search system 100 and transmit the results to the selected viewing device 114. In any case, in block 210, the selected viewing device 114 displays (e.g., generates displayed results based on) the received search results (e.g., the result objects) to the user. In other words, the viewing device 114 renders the result objects of the search results into displayed results. The viewing device 114 then outputs the displayed results to the user (e.g., via a search result viewing app executing on the device 114, for example, as a search engine results page, or “SERP,” within a GUI of the app). The user may interact with the viewing device 114 (e.g., swipe a touchscreen, or use a physical button) to browse through the displayed results. In block 212, the viewing device 114 detects, or receives, the user's selection of one of the displayed results (i.e., a user selection of one of the search results). The user may select a displayed result by interacting in some way with the result. The viewing device 114 may detect the user's selection by detecting the user interaction. In some examples, the user taps a displayed result to select the result. In this example, the viewing device 114 may detect the tapping of the displayed result. For example, the user may tap the entire displayed result to select the result, or the user may tap a region (e.g., a graphical button) of the result to select the result. In general, the user may select a displayed result in any suitable manner, e.g., using voice controls.

In block 214, the viewing device 114 transmits an indication of the user selection (i.e., of the selected result) to a performing device 116. In some examples, the indication includes one or more instructions or commands for the performing device 116. In these examples, the performing device 116 may perform a function specified by the selected result in response to receiving the indication, as described below. For example, the performing device 116 may perform the function using the one or more instructions or commands included in the indication. In one example, to transmit the indication to the performing device 116, the viewing device 114 may broadcast an “intent” (e.g., in the case of the ANDROID® OS) to the device 116 that causes the device 116 to perform the function. In another example, the viewing device 114 may transmit data to the performing device 116 that causes the device 116 to broadcast the intent, thereby causing the device 116 to perform the function.

The viewing device 114 may be any computing device that is capable of receiving search results from the search system 100, displaying the results to users, receiving user selections of the results from the users, and transmitting indications of the user selections to the performing device 116. The viewing device 114 can be, but is not limited to, a wearable computing device (e.g., a smart watch), a smart phone, or a tablet, laptop, or desktop computing device. The viewing device 114 may also be another computing device having another form factor, such as computing device included in a vehicle, a gaming computing device, a television, or another computing device. The viewing device 114 may use a variety of different operating systems, in a similar manner as described above with respect to the searching device 112.

The viewing device 114 may communicate with the search system 100 and/or the performing device 116 via a computer network, such as the Internet. For instance, the viewing device 114 may communicate with the search system 100 in examples where the searching device 112 communicates with the system 100 via the viewing device 114 (e.g., by being tethered to the device 114). In some examples, the viewing device 114 communicates with the search system 100 and/or the performing device 116 using a native app installed on the device 114. In other examples, the viewing device 114 may communicate with the search system 100 and/or the performing device 116 using a more general app, such as a web browser app. Accordingly, as described herein, the viewing device 114 may include at least one of an OS, one or more native apps (e.g., a search result viewing app), and a web browser app that are configured to communicate with the search system 100 and the performing device 116, receive search results from the system 100, display the results to users, receive user selections of the displayed results, and transmit indications of the selected results (i.e., indications of the user selections) to the performing device 116.

In block 216, the performing device 116 performs a function indicated by the selected result in response to receiving the indication. For example, the performing device 116 may perform a function according to an AAM or a WAM associated with the selected result. As described above, in some examples, the performing device 116 performs the function using one or more instructions or commands included in the indication. The performing device 116 can be any computing device that is capable of receiving indications of user selections of search results from a viewing device 114 and performing functions according to the selected results. The performing device 116 can be, but is not limited to, a wearable computing device (e.g., a smart watch), a smart phone, or a tablet, laptop, or desktop computing device. The performing device 116 may also be another computing device having another form factor, such as computing device included in a vehicle, a gaming computing device, a television, or another computing device. The performing device 116 may use a variety of different operating systems, as described above with respect to the searching device 112 and the viewing device 114. The performing device 116 can communicate with the viewing device 114 via a computer network, such as the Internet. In some examples, the performing device 116 communicates with the viewing device 114 using a native app installed on the performing device 116. In other examples, the performing device 116 may communicate with the viewing device 114 using a more general app, such as a web browser app. Accordingly, as described herein, the performing device 116 may include at least one of an OS, one or more native apps, and a web browser app that are configured to communicate with the viewing device 114, receive indications of selected results from the viewing device 114, and perform functions indicated by the selected results.

FIGS. 3 and 4 show examples of the search module 110 and the data store 108 of FIG. 1, and an example function record 400 that may be included in the search system 100 of the present disclosure. The search system 100 (e.g., the search module 110) of FIG. 3 may be configured to communicate with searching devices 112 and viewing devices 114 (and, in some examples, performing devices 116) via a network (e.g., the network 106). In some examples, the devices 112, 114 (and, e.g., devices 116) communicates with the search system 100 via a partner computing system (an intermediate computing device; not shown). The partner computing system may be a computing system of a third party that may leverage the search functionality of the search system 100. The partner computing system may belong to a company or organization other than that which operates the search system 100. Example third parties which may leverage the functionality of the search system 100 include Internet search providers and wireless communications service providers. The devices 112, 114 (and, e.g., devices 116) may send search queries 300 to the search system 100 and receive search results 308 via the partner computing system (and, e.g., retrieve AMs from the system 100). For example, the partner computing system may provide a user interface to the devices 112, 114 (and, e.g., devices 116) and/or modify the search experience provided on the devices 112, 114 (and, e.g., devices 116).

As shown in FIG. 3, the search system 100 is configured to receive a search query 300 from a searching device 112 and perform a search for function records included in the data store 108 based on the received query 300. As described herein, the search system 100 receives the search query 300 generated by the searching device 112 via a viewing device 114 in some examples (e.g., as described with reference to FIG. 11A).

As also shown in FIG. 3, the search system 100 generates search results 308 including one or more result objects based on the received search query 300. For example, the search system 100 may generate the result objects based on data included in function records identified during the search. For instance, the search system 100 may generate a single result object based on data included in a single identified function record. The data store 108 may include one or more function records, some or all of which may be identified during the search of the data store 108. Information that may be included in a function record is described with respect to FIG. 4. The data store 108 may include one or more databases, indices (e.g., inverted indices), tables, files, or other data structures, which may be used to implement the techniques of the present disclosure. For example, the data included in the function records may be included in one or more databases, indices (e.g., inverted indices), tables, files, or other data structures. The search module 110 receives the search query 300 and generates the search results 308 (e.g., the result objects) based on data included in the data store 108 and the received query 300.

The search system 100 performs a search for function records included in the data store 108 in response to the received search query 300 and/or additional data included in a query wrapper that includes the query 300. The search system 100 generates the search results 308 (e.g., the result objects) based on the function records identified during the search. In some examples, the search system 100 generates result scores for the result objects, which are used to rank the objects and the search results 308 (e.g., the displayed results) including the objects. The search system 100 may transmit the result scores to a viewing device 114 selected by the searching device 112 with the result objects, so that the viewing device 114 may rank the objects as part of displaying the search results 308 as the displayed results.

The search system 100 transmits the result objects to the selected viewing device 114. The viewing device 114 generates displayed results based on data included in the result objects. For example, the viewing device 114 may generate a single displayed result for each received result object. In some examples, the viewing device 114 displays only a single displayed result. For example, if the viewing device 114 has a limited amount of display space, the viewing device 114 may generate a displayed result such that it fills the display of the device 114. In other examples, the viewing device 114 may generate a list of displayed results on the display, such that the user can view more than one displayed result at a time.

The search results 308 received by the viewing device 114 from the search system 100 are responsive to the search query 300 transmitted by the searching device 112 to the system 100. The viewing device 114 may execute (e.g., run) a search result viewing app including a GUI that displays the search results 308 received from the search system 100. The GUI of the app may display the search results 308 to the user in a variety of different ways, depending on what information is transmitted to the viewing device 114. In some examples, the GUI displays the search results 308 to the user as a list of displayed results that are ranked based on result scores. The displayed results may be arranged under a search field into which the user may enter a modified search query 300, or another search query 300 (e.g., to modify the search, or to perform a new search). The viewing device 114 may arrange the displayed results in order by result scores associated with the displayed results. In some examples, the viewing device 114 groups multiple ones of the displayed results together if each such result is related to the same native app (e.g., using a header that indicates the app).

The search system 100 may communicate with one or more different data sources (not illustrated), such as the data source(s) 104 of FIG. 1. With reference to the environment of FIG. 1, the data source(s) 104 may be sources of data which the search system 100 may use to generate and update the data store 108. For example, the search system 100 may use the data to update one or more databases, indices, tables, files, or other data structures included in the data store 108. The search system 100 may generate new function records and update existing function records based on data retrieved from the data source(s) 104. Although not illustrated, the search system 100 may include modules that generate new function records and update existing function records based on the data retrieved from the data source(s) 104. In some examples, data included in the data store 108 is manually generated by a human operator.

The data source(s) 104 may include a variety of different data providers. The data source(s) 104 may include data from app developers, such as app developers' websites and data feeds provided by developers. The data source(s) 104 may include operators of digital distribution platforms configured to distribute apps to searching devices 112, viewing devices 114, and performing devices 116. The data source(s) 104 may also include other websites, such as websites that include web logs (i.e., blogs), app review websites, or other websites including data related to apps. Additionally, the data source(s) 104 may include social networking sites, such as FACEBOOK® by Facebook Inc. (e.g., Facebook posts) and TWITTER® by Twitter Inc. (e.g., text from tweets). The data source(s) 104 may also include online databases that include data related to movies, television programs, music, and restaurants. The data source(s) 104 may also include other types of data sources in addition to those described above. Different data sources may have their own content and update rate.

The search system 100 retrieves data from one or more of the data source(s) 104. The retrieved data may include any type of data related to app functionality and/or states. The search system 100 generates function records based on the data retrieved from the data source(s) 104. In some examples, some data included in the function records (e.g., ASI) is manually generated by a human operator. The data included in the function records may be updated over time so that the search system 100 provides up-to-date search results 308.

As described above, the searching device 112, viewing devices 114, performing devices 116, intermediate computing devices (e.g., “intermediate devices”), search system 100, and data source(s) 104 may communicate with one another via a network (e.g., the network 106). The network may include various types of networks, such as a wide area network (WAN) and/or the Internet. Although the network may include a long range network (e.g., the Internet or WAN), in some implementations, the network includes a shorter range network, such as a local area network (a LAN, or a WLAN). In one embodiment, the network uses standard communications technologies and/or protocols. Thus, the network can include links using technologies, such as Ethernet, Wireless Fidelity (Wi-Fi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network can be represented using technologies and/or formats including the hypertext markup language (HTML), the extensible markup language (XML), etc. In addition, all or some of the links can be encrypted using conventional encryption technologies, such as secure sockets layer (SSL), transport layer security (TLS), virtual private networks (VPNs), Internet Protocol security (IPsec), etc. In other examples, the network can use custom and/or dedicated data communications technologies instead of, or in addition to, the ones described above.

The search module 110 includes a query analysis module 302, a consideration set generation module 304 (hereinafter, “set generation module 304”), and a consideration set processing module 306 (hereinafter, “set processing module 306”). The query analysis module 302, set generation module 304, and set processing module 306 may be embodied in computer-executable instructions stored in one or more memory components of the search system 100 and executed by one or more processing units of the search system 100. The query analysis module 302 receives a query wrapper including the search query 300. The query analysis module 302 analyzes the received search query 300. The set generation module 304 identifies a set of one or more function records included in the data store 108 based on the received search query 300. The identified set of function records may be referred to herein as a “consideration set.” The set processing module 306 processes (e.g., scores) the consideration set to generate a set of the search results 308 that include one or more result objects generated based on selected one or more function records of the consideration set.

Referring now to FIG. 4, the example function record 400 includes a function ID 402, ASI 404, one or more AMs 406, and result object data 408. The AM(s) 406 may include one or more native AAMs (hereinafter, “AAMs”), one or more WA Ms, and/or one or more ADAs. The set processing module 306 generates a result object based on the result object data 408, the AM(s) 406, and, in some examples, the function ID 402. The function record 400 may include data related to a function of a native app and/or a state of the app resulting from performance of the function. The data store 108 may include one or more function records each having a structure that is similar to that of the function record 400.

In some examples, a function record includes multiple different AAMs. For example, the different AAMs may be associated with different editions of a native app. A native app edition (hereinafter, “app edition”) may refer to a particular implementation or variation of a native app. For example, an app edition may refer to a version of a native app, such as a version 1.0 or 2.0 of the app. In other examples, an app edition may refer to an implementation of a native app for a specific platform, such as a specific OS, or a device type. The different AAMs included in the function record may cause the corresponding app editions to launch and perform similar functions. Accordingly, the different AAMs may cause the corresponding app editions to be set into similar app states. In one example, if the different AAMs reference different editions of an information retrieval app, the AAMs may cause the corresponding app editions to retrieve similar information. In another example, if the different AAMs reference different editions of an Internet music player app, the AAMs may cause the app editions to play the same song.

In a specific example, a function record for a native app that retrieves restaurant information may include multiple different AAMs for multiple different app editions. Assuming that the function record is associated with a specific Mexican restaurant, the AAMs for the different app editions may cause each app edition to retrieve information for the same Mexican restaurant. For example, a first AAM may cause a first app edition (e.g., for a first OS) to retrieve information for the Mexican restaurant. A second AAM may cause a second app edition (e.g., for a second OS) to retrieve information for the Mexican restaurant. During some searches, the search system 100 may identify one or more function records each including multiple AAMs.

In some examples, a function record includes a WAM, which may be a resource identifier that can be processed by a wide variety of performing devices 116 running different operating systems. For example, the WAM may include a uniform resource locator (URL) (i.e., a web address) used with HTTP. A WAM (e.g., a URL) included in a function record may be used by a web browser app to access a web resource that includes similar information and/or performs similar functions as would be performed by a native app that receives an AAM of the record. As an example, a WAM of a function record may direct a web browser app of a performing device 116 to a web version of a native app referenced by an AAM of the record. For example, if one or more AAMs included in a function record for a specific Mexican restaurant cause each corresponding native app edition to retrieve information for the restaurant, a WAM included in the record may direct a web browser app of the performing device 116 to a web page entry for the same restaurant. During some searches, the search system 100 may identify one or more function records each including one or more AAMs and a WAM.

In some examples, a function record includes one or more ADAs. An ADA of a function record can be used by a user device 102 (e.g., a searching device 112, viewing device 114 and/or performing device 116) to download a native app referenced by one or more AAMs of the record in the event that the app is not installed on the device 102. In some examples, the ADA includes a web address (e.g., a URL) at which the native app can be previewed and downloaded. For example, the ADA may direct a web browser app of the user device 102 to a digital distribution platform configured to distribute native apps. Example digital distribution platforms include GOOGLE PLAY® developed by Google Inc., the APP STORE® developed by Apple Inc., and the WINDOWS PHONE STORE® developed by Microsoft Corporation. If the user device 102 includes a native download app for accessing a digital distribution platform, the ADA may direct the app to a site where the native app referenced by the AAM(s) of the function record can be previewed and downloaded.

The function ID 402 may be used to identify the function record 400 among the other function records included in the data store 108. The function ID 402 may be a string of alphabetic, numeric, and/or symbolic characters (e.g., punctuation marks) that uniquely identify the function record 400. In some examples, the function ID 402 describes a function and/or an app state in human-readable form. For example, the function ID 402 may include a name of a native app referenced by an AAM included in the AM(s) 406. Additionally, or alternatively, the function ID 402 may be a human-readable string that describes a function performed according to the AM(s) 406 and/or an app state resulting from performance of the function. In some examples, the function ID 402 includes a string in the format of a URL of a WAM for the function record 400, which may uniquely identify the function record 400.

In a more specific example, if the function record 400 describes a function of a native app YELP® by Yelp Inc. (hereinafter, “Yelp”), the function ID 402 may include the name “Yelp” along with a description of an app state corresponding to the function, e.g., as described in the ASI 404. In an example where the function record 400 describes an entry in Yelp for the restaurant THE FRENCH LAUNDRY®, the function ID 402 may be “Yelp—The French Laundry.” In an example where the function ID 402 includes a string in the format of a URL, the function ID 402 may include the string “www.yelp.com/biz/the-french-laundry-yountville-2?ob=1” to uniquely identify the function record 400.

The ASI 404 may include data that describes an app state into which a native app is set according to an AAM included in the function record 400 (e.g., in the AM(s) 406). Additionally, or alternatively, the ASI 404 may include data that describes a function performed according to the AM(s) 406. The ASI 404 may include various different types of data, e.g., structured, semi-structured, and/or unstructured data. The ASI 404 may be extracted or inferred from documents retrieved from the data source(s) 104 described above. In some examples, the ASI 404 includes data that is manually generated. The ASI 404 may also be updated so that up-to-date search results 308 can be provided in response to a user's search query 300.

In some examples, the ASI 404 includes data that is presented to a user when a native app referenced by an AAM included in the function record 400 (e.g., in the AM(s) 406) is in an app state defined by the AAM. For example, the ASI 404 may include data that describes the app state of the native app after a performing device 116 has performed one or more operations indicated by the AAM to set the app into the state. In one example, if the function record 400 is associated with a shopping app, the ASI 404 may include data that describes products (e.g., names and prices) that are shown when the app is set into an app state defined by the AM(s) 406 of the function record 400. In another example, if the function record 400 is associated with a music player app, the ASI 404 may include data that describes a song (e.g., a song name and an artist name) that is played when the app is set into an app state defined by the AM(s) 406.

The types of data included in the ASI 404 may depend on the type of information associated with the app state and the functionality defined by the AM(s) 406. In one example, if the function record 400 is for a native app that provides reviews of restaurants, the ASI 404 may include information (e.g., text and numbers) related to a restaurant, such as a category, reviews, and a menu of the restaurant. In this example, the AM(s) 406 may cause the native app to launch and retrieve information for the restaurant. As another example, if the function record 400 is for a native app that plays music, the ASI 404 may include information related to a song, such as a name of the song, an artist name, lyrics, and listener reviews for the song. In this example, the AM(s) 406 may cause the native app to launch and play the song described in the ASI 404.

An AAM (e.g., included in the AM(s) 406) may include an ARI and/or one or more operations for a performing device 116 to perform. For example, the ARI may be a string having an app-specific scheme. The ARI may include a reference to a native app and indicate one or more operations for a performing device 116 (e.g., the app) to perform. For example, the ARI may include the reference to the native app, a domain name, and a path to be used by the app to retrieve and display information to a user.

An example ARI for the native app OPENTABLE® by OpenTable Inc. (hereinafter, “OpenTable”) on the ANDROID® OS is “vnd.opentable.deeplink://opentable.com/restaurant/profile?rid=88333&refid=1.” A portion of the ARI references OpenTable. For example, the substring “vnd.opentable.deeplink” of the ARI references OpenTable. The ARI also indicates one or more operations for OpenTable to perform. For example, OpenTable may retrieve and display the information included in the ARI domain and path defined by the substring “opentable.com/restaurant/profile?rid=88333&refid=1.” In response to receiving the ARI, a performing device 116 may launch OpenTable and display information retrieved from the location indicated by the ARI. For example, a developer of OpenTable may provide the ARI.

In some examples, the AAM includes operations for the performing device 116 to perform in addition to the one or more operations indicated by the ARI. For example, an OS of the performing device 116 and/or a native app installed on the device 116 may perform these additional operations included in the AAM to set a native app into an app state specified by the AAM. In some examples, the operations are included in a script. Examples of the operations include launching a native app, waiting for the app to start, creating and sending a search request to a server, setting a current geo-location in a native app, making a restaurant reservation, sending a text message, and adding an appointment to a calendar. In some examples, an AAM does not include an ARI, but rather other operations (e.g., included in a script) that reference a native app and may be performed by a performing device 116.

As described herein, the function records of this disclosure are not required to have the format shown in FIG. 4. For example, the function records may include information in addition to that included in the function record 400, or less data than that included in the record 400. For instance, a given function record may include a single AAM and no WAM, multiple AAMs and no WAM, and/or a WAM but not an AAM.

Referring back to FIG. 3, the search query 300 received by the search module 110 is used to perform a search of the data store 108. The query analysis module 302 receives the search query 300. The query analysis module 302 may perform various analysis operations on the received search query 300. For example, the analysis operations performed by the query analysis module 302 may include, but are not limited to, tokenization of the search query 300, filtering of the query 300, stemming, synonymization, and stop word removal.

The set generation module 304 identifies a set of function records (i.e., the consideration set) based on the search query 300. In some examples, the set generation module 304 identifies the set of function records based on one or more matches between one or more terms of the search query 300 and one or more terms included in the records. For example, the set generation module 304 may identify the set of function records based on one or more matches between one or more tokens generated by the query analysis module 302 and one or more words included in the records, such as words included in the ASI and/or function IDs of the records. In some examples, the consideration set includes one or more function IDs of the identified function records used to identify the records, rather than the records themselves. As a result, the consideration set may include less data and/or require fewer processing and/or storage resources compared to techniques where the consideration set includes one or more function records.

The set processing module 306 processes the consideration set to generate a set of search results 308 that includes one or more result objects. Each result object may include any of the data described above as being included in a result object. In some examples, the set processing module 306 scores the functions records of the consideration set. The scores associated with the function records may be referred to as “result scores.” In some examples, each function record of the consideration set has a corresponding result score. The set processing module 306 may then select one or more function records from the consideration set based on the result scores associated with the records. For example, the set processing module 306 may select one or more highest-scoring function records of the consideration set.

The set processing module 306 then generates one or more result objects based on the selected function records. For example, the set processing module 306 may generate a single result object based on a single selected function record. The set processing module 306 transmits the result objects to a viewing device 114 selected by the searching device 112. The set processing module 306 may also transmit the result scores associated with the result objects (i.e., with the function records used to generate the objects) to the viewing device 114.

The information conveyed by the search results 308 may depend on how the set processing module 306 calculates the result scores. The result scores may indicate relevance of an app function or state to the search query 300, popularity of an app function or state, or other properties of the app function or state, depending on which parameters the set processing module 306 uses to score the function records of the consideration set.

The set processing module 306 may generate result scores for function records in a variety of different ways. In some examples, the set processing module 306 generates a result score for a function record based on one or more scoring features. The scoring features may be associated with the function record and/or the search query 300. A function record scoring feature (hereinafter, a “record scoring feature”) may be based on any data associated with a function record. For example, record scoring features may be based on any data included in ASI of a function record. A query scoring feature may include any data associated with the search query 300. For example, query scoring features may include a number of words in the search query 300, popularity of the query 300, and an expected frequency of the words in the query 300. A record-query scoring feature may include any data which may be generated based on data associated with both a function record and the search query 300 that resulted in identification of the record by the set generation module 304. For example, record-query scoring features may include parameters that indicate how well terms of the search query 300 match terms of ASI of an identified function record. In some examples, determining such record-query scoring features, i.e., parameters that indicate how well terms of a search query 300 match terms of ASI of an identified function record, are performed using Lucene® information retrieval software developed by the Apache Software Foundation. The set processing module 306 may generate a result score for a function record based on at least one of the record scoring features, query scoring features, and record-query scoring features.

The set processing module 306 may determine a result score for a function record included in the consideration set based on one or more of the scoring features listed herein and/or additional scoring features not explicitly listed. In some examples, the set processing module 306 includes one or more machine-learned models (e.g., a supervised learning model) configured to receive one or more scoring features. The machine-learned models may generate result scores for function records included in the consideration set based on at least one of the record scoring, query scoring, and record-query scoring features. For example, the set processing module 306 may pair the search query 300 with each function record included in the consideration set and calculate a vector of features for each (query, record) pair. The vector of features may include one or more record scoring, query scoring, and record-query scoring features. The set processing module 306 may then input the vector of features into a machine-learned regression model to calculate a result score for the corresponding function record. In some examples, the machine-learned regression model includes a set of decision trees (e.g., gradient boosted decision trees). In other examples, the machine-learned regression model may include a logistic probability formula. In some examples, the machine-learned task described above can be framed as a semi-supervised learning task, where a minority of the training data is labeled with human-curated scores, and the rest of the training data is used without human labels. The result scores associated with the function records of the consideration set may be used in a variety of different ways described herein.

FIGS. 5A-5C illustrate example GUIs that may be displayed on a searching device 500 and viewing devices 510 and 518. The searching device 500 shown in FIG. 5A is a wrist watch computing device (e.g., a smart watch) including watch straps 502. Example wrist watch computing devices include the SAMSUNG GALAXY GEAR®, the SAMSUNG GALAXY GEAR® 2, the SAMSUNG GEAR® 2 Neo, and the SAMSUNG GEAR FIT® developed by Samsung Electronics Co., Ltd., as well as the APPLE WATCH® developed by Apple Inc. The viewing devices 510, 518 shown in FIGS. 5B and 5C are a tablet computing device and a smart phone computing device, respectively. Referring to FIG. 5A, the searching device 500 executes a search app including a GUI 504 that displays a search field 506 for receiving search queries 300 from a user. Because the searching device 500 has a small form factor (e.g., a small screen), in some examples, the searching device 500 does not include a full keyboard. In these examples, the searching device 500 may receive search queries 300 in a different manner, such as using voice input. For example, the user may tap the search field 506 and speak into the searching device 500 to enter a search query 300 into the field 506. The searching device 500 may then transmit the entered search query 300 to the search system 100. In some examples, the searching device 500 automatically transmits the search query 300 after receiving the query 300. In other examples, the user may press a search button 508 also included in the GUI 504 to transmit the search query 300 to the search system 100.

In the example of FIG. 5A, the user has entered the search query “Late night diners” 300 into the search field 506 displayed by the GUI 504 of the searching device 500. The searching device 500 has subsequently transmitted the search query 300 to the search system 100. The search system 100 has generated search results 308 in response to the search query 300. As shown in FIGS. 5B and 5C, the search results 308 are associated with entries in Yelp for “IHOP” and “Denny's,” with native apps TRIPADVISOR® by TripAdvisor, LLC (hereinafter, “TripAdvisor”) and URBANSPOON® by Wanderspot LLC (hereinafter, “Urbanspoon”), and with a web version of OpenTable. Specifically, the search system 100 has identified function records included in the data store 108 that correspond to the entries in Yelp for “IHOP” and “Denny's,” and to TripAdvisor, Urbanspoon, and the web version of OpenTable. To generate the search results 308, the search system 100 may have generated result objects using the identified function records. For example, the search system 100 may have selected AAMs that enable a performing device 116 to launch Yelp and retrieve the entries in Yelp for “IHOP” and “Denny's,” from the identified function records. The search system 100 may have also selected AAMs that enable the performing device 116 to launch TripAdvisor and Urbanspoon, e.g., into default, or main states, from the identified function records. The search system 100 may have further selected a WAM for a web-based version of OpenTable from the identified function records. For example, the WAM may direct a web browser app of the performing device 116 to one or more late night diners within the OpenTable web-based app.

The searching device 500 has further selected one of the viewing devices 510, 518 to display the search results 308, as described herein. For example, the searching device 500 may have selected one of the viewing devices 510, 518 using any of a user input received from the user, and location, availability, compatibility, connectivity, historical connectivity, and previous selection data associated with the selected one of the viewing devices 510, 518, as also described herein. The search system 100 has transmitted the search results 308 to the selected one of the viewing devices 510, 518 (e.g., in response to receiving viewing device selection data that identifies the selected viewing device from the searching device 500). As shown in each of FIGS. 5B and 5C, the corresponding one of the selected viewing devices 510, 518 has displayed the search results 308 on the respective viewing device. Each of the search results 308 (e.g., each of the result objects included in the results 308) may be transmitted to the selected one of the viewing devices 510, 518 at the same time. Accordingly, those of the search results 308 that are not displayed on the selected viewing device may be stored in memory of the device, e.g., to be displayed on the device at a later point in time. The user may interact with the selected viewing device (e.g., swipe a screen of the device, or use a physical button of the device) to browse through the displayed results and display the stored search results 308. For example, the user may swipe downward to advance through the displayed results and then swipe upward to back up, or move in an opposite direction, through the results.

FIG. 5B shows the viewing device 510 displaying the search results 308 received from the search system 100 in response to the searching device 500 selecting the device 510, as described above. As shown in FIG. 5B, the viewing device 510 displays the search results 308 as user selectable links (“links”) 512, 514-1, 514-2, and 516. The links 514-1 and 514-2 are associated with the entries in Yelp for “IHOP” and “Denny's,” respectively. The link 512 is a Yelp “header” for grouping the links 514-1, 514-2. The link 516 is associated with TripAdvisor. The user may select (e.g., touch, or click on) any of the links 512, 514-1, 514-2, and 516 shown in FIG. 5B. In some examples, the user selects a particular link by tapping within the corresponding region of the display of the viewing device 510. In other examples, the user may select a particular link using a mechanical button of the viewing device 510. The user may also interact with (e.g., swipe the display of) the viewing device 510 to introduce other links to the display and remove the links shown in FIG. 5B from the display.

FIG. 5C shows the viewing device 518 displaying the search results 308 received from the search system 100 in response to the searching device 500 selecting the device 518, as also described above. As shown in FIG. 5C, the viewing device 518 displays the search results 308 as links 524, 526-1, 526-2, 528, 530, and 532. The links 526-1 and 526-2 are associated with the entries in Yelp for “IHOP” and “Denny's.” respectively. The link 524 is a Yelp “header” for grouping the links 526-1, 526-2. The links 528, 530, and 532 are associated with TripAdvisor, the web version of OpenTable, and Urbanspoon, respectively. The user may select (e.g., touch, or click on) any of the links 524, 526-1, 526-2, 528, 530, and 532 shown in FIG. 5C. In some examples, the user selects a particular link by tapping within the corresponding region of the display of the viewing device 518. In other examples, the user may select a particular link using a mechanical button of the viewing device 518. The user may also interact with (e.g., swipe the display of) the viewing device 518 to introduce other links to the display and remove the links shown in FIG. 5C from the display. As also shown in FIG. 5C, the viewing device 518 further displays a search field 520 that includes the search query 300, and a search button 522, which may enable the user to modify the query 300, or enter a new search query 300, and submit the modified or new query 300 to the search system 100 via the device 518 to perform a modified or new search using the query 300.

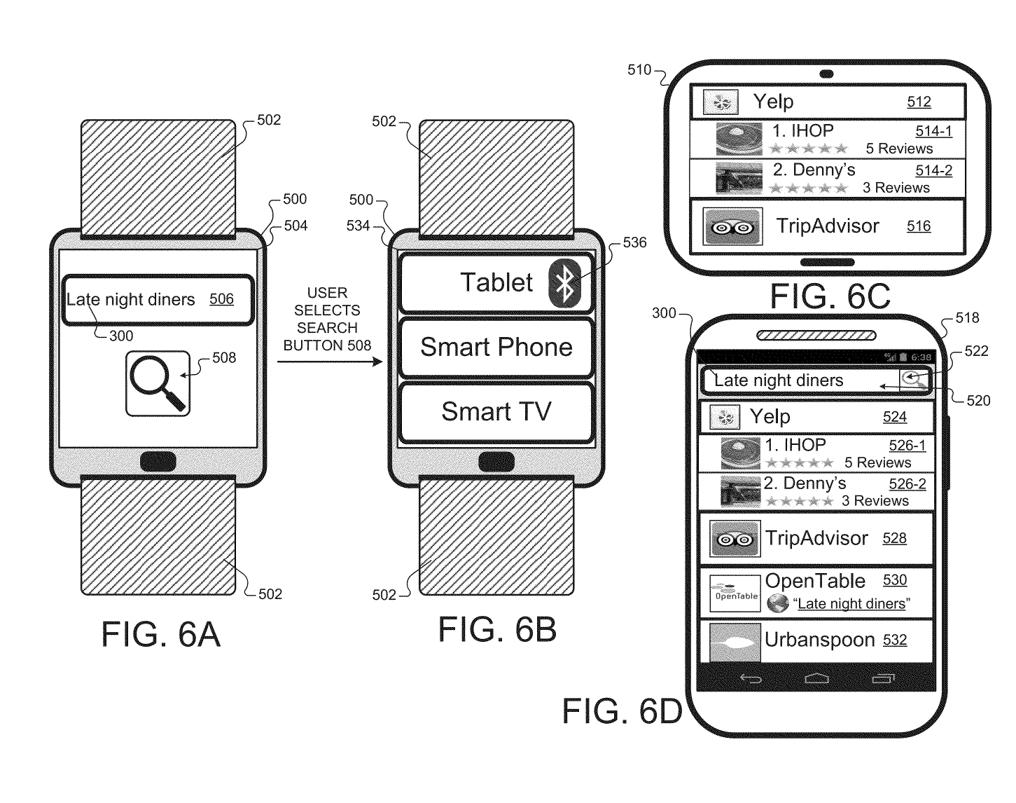

FIGS. 6A-6D illustrate other example GUIs that may be displayed on the searching device 500 and the viewing devices 510 and 518. FIGS. 6A, 6C, and 6D are analogous to FIGS. 5A, 5B, and 5C, respectively, and include some of the same or similar elements (e.g., user selectable links, headers, and other GUI elements, such as search fields, search buttons, and other buttons or links) as those described above with reference to FIGS. 5A-5C. As described herein, in some examples, the searching device 500 automatically selects one of the viewing devices 510, 518 to display search results 308 received from the search system 100 in response to the device 500 transmitting a search query 300 to the system 100. In other examples, as shown in FIGS. 6A-6D, the searching device 500 may select one of the viewing devices 510, 518 to display the search results 308 based on a user input received from a user of the device 500. Specifically, FIG. 6B shows an example GUI 534 displayed on the searching device 500 that prompts the user to select one of the viewing devices 510, 518 to display the search results 308.

In the example of FIGS. 6A-6D, the searching device 500 may display the GUI 534 prior to, in parallel with, and/or following the searching device 500 transmitting the search query 300 to the search system 100. For example, the searching device 500 may display the GUI 534 after the user causes the device 500 to transmit the search query 300 to the search system 100 (e.g., by selecting the search button 508), as described above. As shown in FIG. 6B, the GUI 534 includes multiple user selectable links (“links”) that each indicate one of multiple viewing devices 114 (i.e., tablet, smart phone, and smart television computing devices), each of which may display the search results 308. In this example, the user may select any of the multiple viewing devices 114 by selecting (e.g., touching, or clicking on) the corresponding one of the links. After the user selects one of the multiple viewing devices 114 (i.e., one of the links), the selected viewing device 114 displays the search results 308 (e.g., as shown in each of FIGS. 6C and 6D). For example, upon the user selecting one of the multiple viewing devices 114, the searching device 500 may indicate to the selected viewing device 114 (e.g., via the search system 100 and/or using viewing device selection data) that the viewing device 114 is to display the search results 308. As also shown in FIG. 6B, in some examples, one or more of the links displayed to the user indicate whether the corresponding viewing device 114 is currently connected to the searching device 500 (e.g., via a Bluetooth logo 536 shown in FIG. 6B). In other examples (not shown), one or more of the links may indicate to the user any of location, availability, compatibility, historical connectivity, and previous selection data associated with the corresponding viewing device 114. In any case, in the example of FIG. 6C, the user has selected the viewing device 510 using the GUI 534 by selecting the link including the string “Tablet.” Similarly, in the example of FIG. 6D, the user has selected the viewing device 518 using the GUI 534 by selecting the link including the string “Smart Phone.”

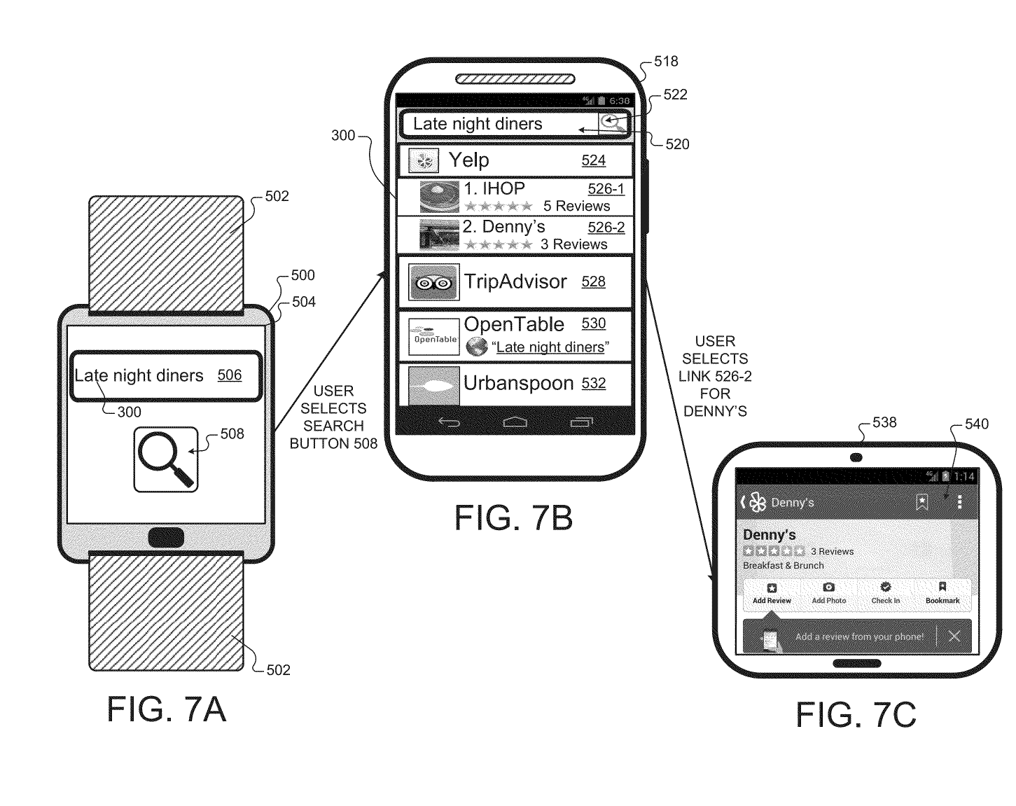

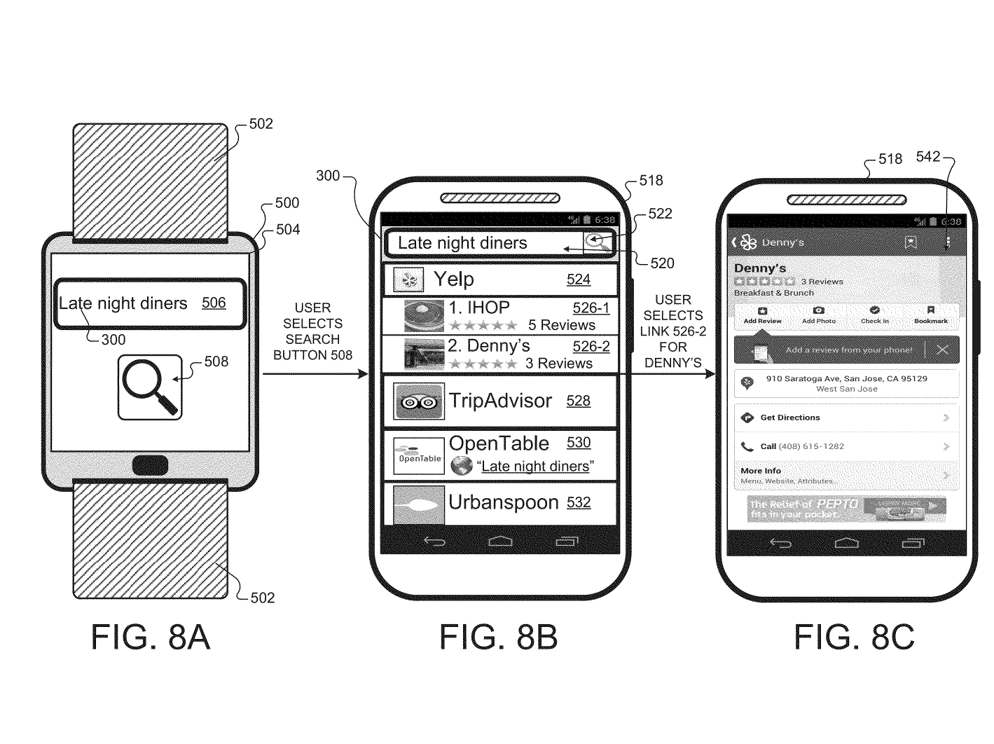

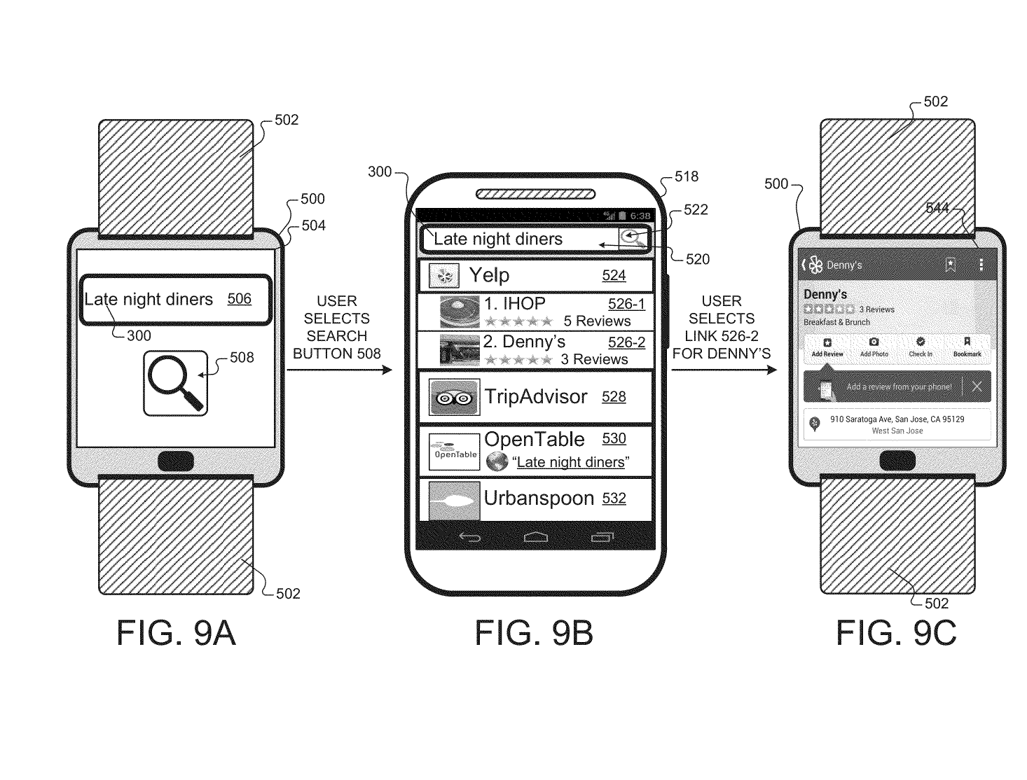

FIGS. 7A-9C illustrate example GUIs that may be displayed on the searching device 500, the viewing device 518, and various performing devices 116. FIGS. 7A, 7B, 8A, 8B, 9A, and 9B are analogous to FIGS. 5A and 5C and include some of the same or similar elements (e.g., user selectable links, headers, and other GUI elements, such as search fields, search buttons, and other buttons or links) as those described above with reference to FIGS. 5A and 5C. In each of FIGS. 7A, 7B, 8A, 8B, 9A, and 9B, the user causes the searching device 500 to transmit the search query 300 to the search system 100 (e.g., by selecting the search button 508), as described above. In these examples, the searching device 500 selects the viewing device 518, upon which the viewing device 518 receives the search results 308 that are responsive to the search query 300 from the search system 100, and displays the results 308 to the user, as also described above. Each of FIGS. 7C, 8C, and 9C, in turn, shows an example GUI displayed on a performing device 116 that performs a function indicated by one of the search results 308 that has been displayed to the user on the viewing device 518 and subsequently selected by the user at the viewing device 518. In the example of FIGS. 7A-9C, the selected search result 308 corresponds to the link 526-2 for the entry in Yelp for “Denny's.” Specifically, FIG. 7C shows a performing device 538, which is a tablet computing device that displays a GUI 540. The GUI 540 corresponds to the performing device 538 launching Yelp into the app state that corresponds to the entry in Yelp for “Denny's.” In contrast, FIG. 8C shows the viewing device 518 acting as the performing device 116. A GUI 542 displayed by the viewing device 518 in FIG. 8C corresponds to the viewing device 518 launching Yelp into the app state that corresponds to the entry in Yelp for “Denny's.” Additionally, FIG. 9C shows the searching device 500 acting as the performing device 116. A GUI 544 displayed by the searching device 500 in FIG. 9C corresponds to the searching device 500 launching Yelp into the same “Denny's” app state.

FIGS. 10A-11B are functional block diagrams that illustrate different arrangements of searching devices 112, viewing devices 114, and the search system 100. The different arrangements are now described. FIGS. 10A and 10B show examples in which a single searching device 1000, 1006 and multiple different viewing devices 1002, 1004, 1008, 1010 each have independent network access (i.e., via the network 106) to the search system 100. Put another way, the searching device 1000, 1006 is not tethered to any of the viewing devices 1002, 1004, 1008, 1010 in FIGS. 10A and 10B. For example, with reference to FIG. 10A, the searching device 1000 may communicate with the search system 100 using a Wi-Fi connection, a cellular network connection, or other communication technology. Each of the viewing devices 1002, 1004 may also communicate with the search system 100 using a Wi-Fi connection, a cellular network connection, or other communication technology. In some examples, the searching device 1000 and one or more of the viewing devices 1002, 1004 communicate with the search system 100 using different communication technologies. In other examples, the searching device 1000 and one or more of the viewing devices 1002, 1004 may communicate with the search system 100 using the same communication technology. In some examples, the searching device 1000 and one or more of the viewing devices 1002, 1004 are connected to the search system 100 through the same computing network (e.g., a home network, or a business network).

In some examples, the searching device 1000 is communicatively coupled to one or more of the viewing devices 1002, 1004 via the network 106, as shown in in the example of FIG. 10A. In other examples, the searching device 1000 and one or more of the viewing devices 1002, 1004 may communicate directly with one another, such as through a Bluetooth connection, a near field communication (NFC) connection, or another direct connection. In the above-described examples, the searching device 1000 may communicate with (e.g., receive data from, and transmit data to) one or more of the viewing devices 1002, 1004 via the network 106 or the direct connection. For example, as described herein, the searching device 1000 may receive data from one or more of the viewing devices 1002, 1004 that indicates any of location, availability, compatibility, (e.g., historical) connectivity, or other data associated with the corresponding device(s). As also described herein, in some examples, the searching device 1000 selects one of the viewing devices 1002, 1004 based on the received data for viewing search results 308 generated in response to a search query 300 received by the searching device 1000.

FIG. 10B illustrates an example searching device 1006 and example viewing devices 1008, 1010. The searching device 1006 is a wrist watch computing device (e.g., a smart watch). The viewing devices 1008, 1010 are a smart phone computing device and a smart television computing device, respectively. In some examples, the searching device 1006 and one or more of the viewing devices 1008, 1010 independently communicate with the search system 100. In other examples, the searching device 1006 may communicate directly with one or more of the viewing devices 1008, 1010 (e.g., via a Bluetooth, NFC, or another direct connection).

FIGS. 11A and 11B show example arrangements of computing devices in which a searching device 1100 or a first viewing device 1108 is tethered to another computing device (e.g., a first viewing device 1102 or a searching device 1106) to communicate with the search system 100 (i.e., via the network 106). In FIG. 11A, the searching device 1100 is tethered to the first viewing device 1102. In this example, the searching device 1100 may transmit search queries 300 to the search system 100 via the first viewing device 1102. Also in this example, the first viewing device 1102 may receive search results 308 that are responsive to the search queries 300 directly from the search system 100. The searching device 1100 may be tethered to the first viewing device 1102 because the searching device 1100 may not have sufficient communication technology for communicating via the Internet with the search system 100. For example, the searching device 1100 may have a communication technology (e.g., Bluetooth, or NFC) that cannot connect to the Internet at the device's 1100 current location. In FIG. 11A, the searching device 1100 may communicate directly with the first viewing device 1102 via the tethered connection. For example, if the searching device 1100 is connected to the first viewing device 1102 via a Bluetooth or NFC connection, the searching device 1100 may communicate with (e.g., receive data from, and transmit data to) the first viewing device 1102 using the Bluetooth or NFC connection. For instance, as described herein, the searching device 1100 may receive data from the first viewing device 1102 that indicates any of location, availability, compatibility, (e.g., historical) connectivity, or other data associated with the first viewing device 1102. In the example of FIG. 11A, the first and second viewing devices 1102, 1104 may each have independent network access (i.e., via the network 106) to the search system 100. In other examples, the searching device 1100 may be tethered to the second viewing device 1104 in a similar manner as described above with reference to the first viewing device 1102.

In FIG. 11B, the first viewing device 1108 is tethered to the searching device 1106. In this example, the searching device 1106 may transmit search queries 300 to the search system 100 and receive search results 308 from the system 100. Also in this example, the first viewing device 1108 may receive the search results 308 from the search system 100 via the searching device 1106. The first viewing device 1108 may be tethered to the searching device 1106 because the first viewing device 1108 may not have sufficient communication technology for communicating via the Internet with the search system 100. For example, the first viewing device 1108 may have a communication technology (e.g., Bluetooth, or NFC) that cannot connect to the Internet at the device's 1108 current location. In FIG. 11B, the searching device 1106 may communicate directly with the first viewing device 1108 via the tethered connection. For example, if the searching device 1106 is connected to the first viewing device 1108 via a Bluetooth or NFC connection, the searching device 1106 may communicate with (e.g., receive data from, and transmit data to) the first viewing device 1108 using the Bluetooth or NFC connection, in a similar manner as described above. In the example of FIG. 11B, the searching device 1106 and the second viewing device 1110 may each have independent network access (i.e., via the network 106) to the search system 100. In other examples, the second viewing device 1110 may be tethered to the searching device 1106 in a similar manner as described above with reference to the first viewing device 1108.

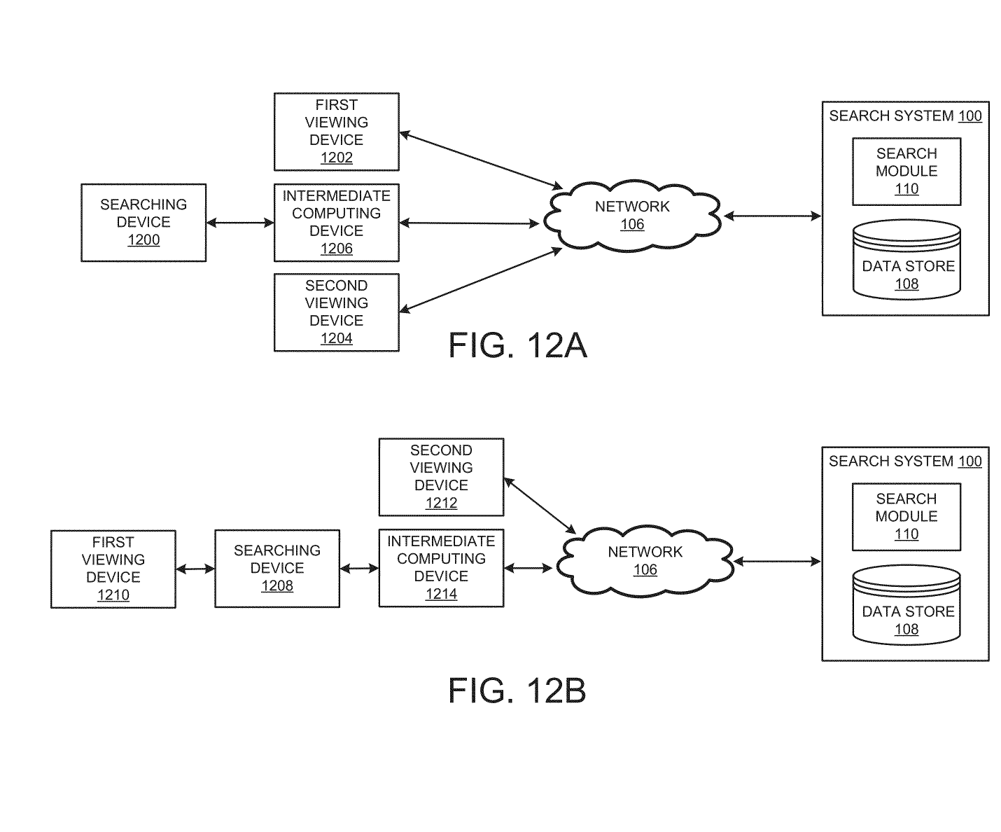

FIGS. 12A and 12B are functional block diagrams that illustrate other example arrangements of computing devices in which a searching device 1200, 1208 is tethered to another computing device referred to herein as an “intermediate computing device,” or an “intermediate device,” 1206, 1214 to communicate with the search system 100. In other words, in the examples of FIGS. 12A and 12B, the searching device 1200, 1208 may communicate with the search system 100 via the intermediate device 1206, 1214. As described herein, the searching device 1200, 1208 selects one of a first viewing device 1202, 1210 and a second viewing device 1204, 1212, each of which is a different computing device than the intermediate device 1206, 1214. As also described herein, in some examples, the searching device 1200, 1208 selects one of the first and second viewing devices 1202, 1204, 1210, 1212 by communicating with one or more of the devices via a direct connection (e.g., the direct connection between the searching device 1208 and the first viewing device 1210 shown in FIG. 12B). As further described herein, in other examples, the searching device 1200, 1208 may communicate with one or more of the first and second viewing devices 1202, 1204, 1210, 1212 via the Internet as part of selecting one of the devices in the manner described above.

FIGS. 12A and 12B also illustrate how the searching device 1200, 1208 may select more than one of the viewing devices 1202, 1204, 1210, 1212 (e.g., based on a user input, or the other considerations described herein). For instance, with respect to FIG. 12A, the searching device 1200 may select the first viewing device 1202 and/or the second viewing device 1204. The viewing device(s) (i.e., the one or more of the viewing devices 1202, 1204) selected by the searching device 1200 may then receive search results 308 from the search system 100 and display the results 308, as described herein. The connections between the searching device 1200 and the first and second viewing devices 1202, 1204 may be direct connections and/or connections through a network (e.g., the network 106), such as the Internet. In the example of FIG. 12A, the intermediate device 1206 and the first and second viewing devices 1202, 1204 may each have independent network access (i.e., via the network 106) to the search system 100. With respect to FIG. 12B, the searching device 1208 is tethered to the intermediate device 1214 to communicate with the search system 100 (i.e., via the network 106). The searching device 1208 may select the first viewing device 1210 and/or the second viewing device 1212. The viewing device(s) (i.e., the one or more of the viewing devices 1210, 1212) selected by the searching device 1208 may then receive search results 308 from the search system 100 (e.g., via the intermediate device 1214 and the searching device 1208) and display the results 308, as described herein. The connections between the searching device 1208 and the first and second viewing devices 1210, 1212 may be direct connections (e.g., the direct connection between the searching device 1208 and the first viewing device 1210) and/or connections through a network, e.g., the network 106 (via the intermediate device 1214), such as the Internet. In the example of FIG. 12B, the intermediate device 1214 and the second viewing device 1212 may each have independent network access (i.e., via the network 106) to the search system 100. In other examples, the searching device 1208 may be tethered to one of the first and second viewing devices 1210, 1212, which may in turn be tethered to the intermediate device 1214. In these examples, the intermediate device 1214 may communicate with the search system 100 as described above. Additional arrangements of searching devices, viewing devices, and intermediate devices are also contemplated herein view of the above-described examples.

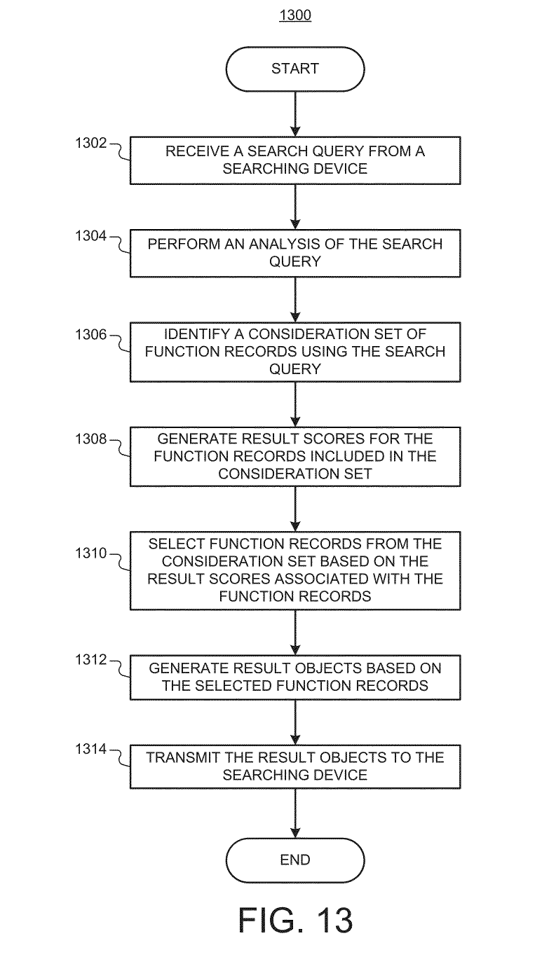

FIG. 13 is a flow diagram that illustrates an example method 1300 for generating search results 308 based on a received search query 300. The method 1300 is described with reference to the search module 110 of FIG. 3, and the various components thereof. In block 1302, the query analysis module 302 receives a search query 300 from (e.g., generated by) a searching device 112. For example, the searching device 112 may have received the search query 300 from a user of the device 112 (e.g., via a GUI of a search app executing on the device 112), and transmitted the query 300 to the query analysis module 302 (i.e., to the search system 100). In block 1304, the query analysis module 302 performs an analysis of the search query 300. For example, the query analysis module 302 may perform any of tokenization, filtering, stemming, synonymization, and stop word removal with respect to the search query 300. In block 1306, the set generation module 304 identifies a consideration set of one or more function records included in the data store 108 using the search query 300 (e.g., using an output of the query analysis module 302). For example, the set generation module 304 may identify the function records of the consideration set based on one or more matches between one or more terms of the search query 300 and one or more terms of ASI and/or a function ID of each record.

In blocks 1308-1310, the set processing module 306 processes the consideration set of function records. Specifically, in block 1308, the set processing module 306 generates one or more result scores for the function records included in the consideration set. For example, the set processing module 306 may generate a result score for each function record included in the consideration set. In block 1310, the set processing module 306 selects one or more function records from the consideration set based on the result scores associated with the records. For example, the set processing module 306 may select one or more function records included in the consideration set having the highest (e.g., largest) one or more result scores. In block 1312, the set processing module 306 generates one or more result objects based on (e.g., using data included in) the selected function records. In block 1314, the set processing module 306 transmits the result objects to the searching device 112 (i.e., as the search results 308).

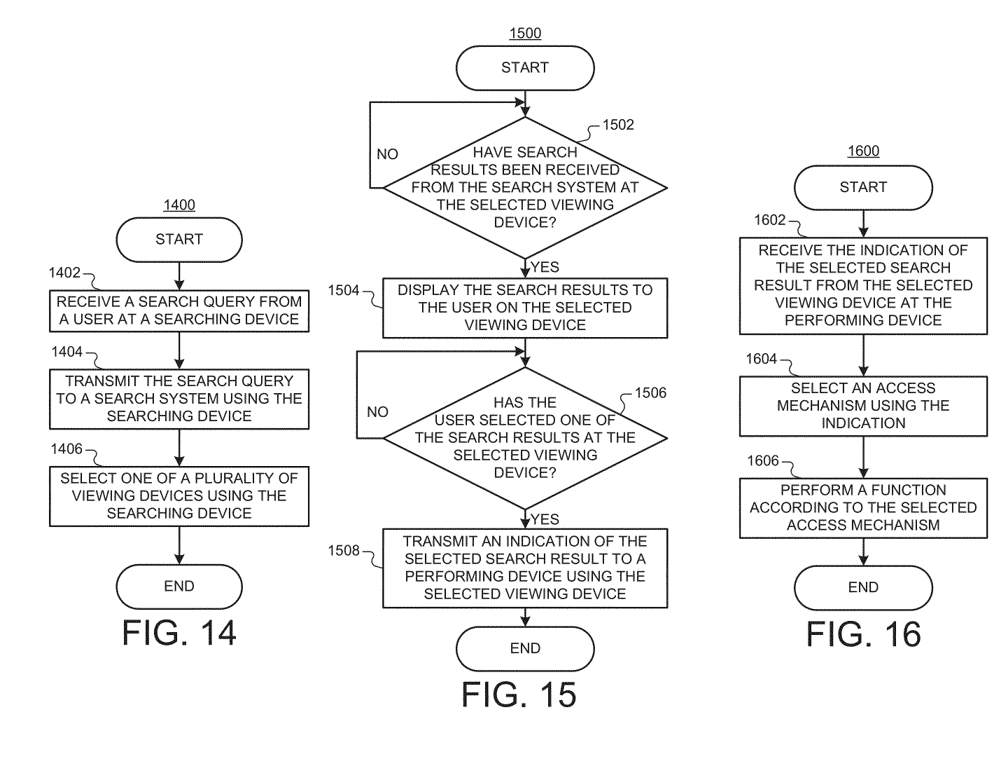

FIG. 14 is a flow diagram that illustrates an example method 1400 describing operation of a searching device 112 according to the present disclosure. In block 1402, the searching device 112 receives a search query 300 from a user of the device 112. For example, the searching device 112 may have received the search query 300 from the user via a GUI of a search app executing on the device 112. In block 1404, the searching device 112 transmits the search query 300 to the search system 100. In block 1406, the searching device 112 selects one of a plurality of viewing devices 114 for viewing search results 308 generated by the search system 100 in response to receiving the search query 300 from the searching device 112. As described herein, in some examples, the searching device 112 selects the one of the plurality of viewing devices 114 based on a user input received from the user. As also described herein, in other examples, the searching device 112 may select the one of the plurality of viewing devices 114 based on one or more of location, availability, compatibility, connectivity, historical connectivity, and previous selection data associated with the one of the plurality of viewing devices 114, as well as any number of other considerations.

FIG. 15 is a flow diagram that illustrates an example method 1500 describing operation of a viewing device 114 according to the present disclosure. The viewing device 114 described with reference to the example method 1500 has been selected from among a plurality of viewing devices 114 by a searching device 112 for viewing search results 308 generated by the search system 100 in response to receiving a search query 300 from the searching device 112, as described above with reference to the example method 1400 of FIG. 14. In block 1502, the selected viewing device 114 waits to receive the search results 308 from the search system 100 in response to the searching device 112 transmitting the search query 300 to the system 100. The method 1500 continues in block 1504 when the selected viewing device 114 receives the search results 308 that are responsive to the search query 300 from the search system 100. In block 1504, upon receiving the search results 308 from the search system 100, the selected viewing device 114 displays (e.g., via a GUI of a search app executing on the device 114) the results 308 to the user (e.g., generates displayed results based on the results 308). In block 1506, the selected viewing device 114 waits for the user to select one of the search results 308 displayed to the user (e.g., one of the displayed results) at the device 114. The method 1500 continues in block 1508 when the user selects one of the search results 308 displayed to the user at the selected viewing device 114. In block 1508, upon the user selecting one of the search results 308 displayed to the user at the selected viewing device 114, the device 114 transmits an indication of the selected search result 308 (e.g., of a selected result) to a performing device 116 that is configured to perform a function indicated by the result 308. As described herein, in some examples, the indication includes or references one or more AAMs, WAMs, and/or ADAs. As also described herein, in other examples, the indication may include one or more instructions or commands for the performing device 116.

FIG. 16 is a flow diagram that illustrates an example method 1600 describing operation of a performing device 116 according to the present disclosure. The performing device 116 described with reference to the example method 1600 receives an indication of a search result 308 that has been displayed to a user on a selected viewing device 114, and selected by the user at the selected viewing device 114, as described above with reference to the example method 1500 of FIG. 15. In the example method 1600, the performing device 116 is configured to perform a function indicated by the selected search result 308, as also described above. The performing device 116 of the example method 1600 may be any of the searching device 112 and the selected viewing device 114 described above with reference to the example methods 1400 and 1500 of FIGS. 14 and 15, respectively, or another user device 102.

In block 1602, the performing device 116 receives the indication of the selected search result 308 (e.g., a selected result) from the selected viewing device 114. The indication may include a variety of different types of data. For example, the indication may include one or more AMs. In some examples, the indication includes one or more AAMs. Additionally, or alternatively, the indication may include a WAM. In some examples, the indication includes an ADA, e.g., along with the AAM(s) in cases where a native app referenced by the AAM(s) is not installed on the performing device 116. In other examples, the indication may reference, rather than include, one or more of the AAM(s), WAM, and ADAs. In still other examples, the indication may include one or more instructions or commands for the performing device 116.

In block 1604, the performing device 116 selects an AM using the indication received from the selected viewing device 114. For example, the performing device 116 may select an AAM (e.g., from the indication itself, or using the indication as a reference) in the event the device 116 has a native app that is referenced by the AAM installed on the device 116. In another example, the performing device 116 may select a WAM (e.g., from the indication itself, or using the indication as a reference) in the event the device 116 does not have a native app that is referenced by an AAM included in, or referenced by, the indication installed on the device 116. In still other examples, in the event the indication includes, or references, an ADA, the performing device 116 may be directed to a download site, or another location (e.g., a digital distribution platform) where the device 116 may download a native app. Upon downloading the native app, the performing device 116 may install the app on the device 116. In these examples, the native app may be referenced by an AAM also included in, or referenced by, the indication.

In block 1606, the performing device 116 performs a function according to the selected AM. For example, if the selected AM is an AAM, the performing device 116 may launch a native app referenced by the AAM on the device 116 and set the launched app into an app state specified by the AAM. In some examples, prior to launching the native app and setting the app into the app state, the performing device 116 downloads and installs the native app using an ADA included in the AM. If the selected AM is a WAM, the performing device 116 may launch a web browser app included on the device 116, and perform a function specified by the WAM (e.g., access a web resource using a URL, or a web address, included in the WAM).

As described herein, in some examples, upon receiving an indication of a selected result, instead of launching a native app and setting the app into a particular state, or launching a web browser app and accessing a web resource, the performing device 116 can show an expanded view of the result (e.g., a view that includes more image/text content, or detail and/or GUI input/output options). This may be beneficial when the user would like to view the selected result on a larger screen, assuming that the viewing device 114 (e.g., a smart phone) has a relatively limited display screen size and that the performing device 116 (e.g., a smart television) has a relatively larger display screen size. The user may then interact with the expanded view to cause the performing device 116 to launch a native app and set the app into a particular state, or launch a web browser app and access a web resource.

In some examples, the viewing device 114 automatically (e.g., without additional user input) indicates to the performing device 116 that an expanded view of a selected result should be shown on the device 116. In other examples, the viewing device 114 may prompt the user to select whether the expanded view should be shown on the performing device 116, or whether a native app referenced by the result should be launched by the performing device 116 using the result. For example, after the user selects a displayed result on the viewing device 114, the device 114 may display a button or another GUI input element that includes the string “Show expanded view” or “Launch app.” In this manner, the button or GUI input element may enable the user to select whether the performing device 116 should display an expanded view of the selected result, or launch a native app referenced by the result. If the user selects the button/GUI input element that includes the string “Show expanded view,” the viewing device 114 may transmit an indication to the performing device 116 to show an expanded view of the selected result. If the user selects the button/GUI input element that includes the string “Launch app,” the viewing device 114 may transmit an indication to the performing device 116 to launch the native app according to the selected result. The performing device 116 may then launch the native app and set the app into an app state specified by the selected result.

In some examples, the viewing device 114 stores search results 308 for later use (e.g., based on a user input, or other considerations). For example, at a later time following performing a search using a searching device 112, the user may recall a stored search result 308 on the viewing device 114 and select the result 308 to cause a performing device 116 to perform a function indicated by the result 308. In one example in which the viewing device 114 is a wrist watch computing device (e.g., a smart watch), the device 114 may store search results 308 so that the user can easily retrieve the results 308 at a later time for selection, as described above. Storing search results 308 on the viewing device 114 in this manner may save the user time that would otherwise be spent performing a new search for the results 308. In some examples, the viewing device 114 stores some of the search results 308. For example, the viewing device 114 may maintain a history of (i.e., store) previously selected search results 308. A stored search result 308 may include some or all of the result object data associated with a search result 308 such that, upon selection of the stored search result 308, a viewing device 114 can indicate to a performing device 116 to perform a function associated with the stored search result 308, and the performing device 116 is able to perform the function. In some examples, stored search results 308 are stored on computing devices other than the viewing device 114 (e.g., a searching device 112, a performing device 116, or another computing device). In other examples, the viewing device 114 can transfer the stored search results 308 to one or more other computing devices (e.g., a searching device 112, a performing device 116, or another computing device).

As described herein, in some examples, there are multiple possible viewing devices 114 that may be used to display search results 308. In some examples, the searching device 112 ranks the possible viewing devices 114 for displaying the search results 308. For example, the searching device 112 may rank the possible viewing devices 114 based on a variety of different considerations. Example ranking considerations may include, but are not limited to, one or more of physical proximity of the searching device 112 and a possible viewing device 114, whether the searching device 112 has just selected (e.g., within seconds) a possible viewing device 114 to display other search results 308, whether a possible viewing device 114 is currently performing a function indicated by a selected result (e.g., assuming the viewing device 114 is used as a performing device 116), whether a possible viewing device 114 has a sufficient display technology and/or size for displaying the search results 308, whether a possible viewing device 114 has a native app capable of performing the chosen function (e.g., as indicated by the selected result; assuming the viewing device 114 may be used as a performing device 116), whether the searching device 112 and a possible viewing device 114 are or have been previously connected (e.g., via Bluetooth, or NFC), and whether and/or how often the searching device 112 has selected a possible viewing device 114 in the past. In some examples, the searching device 112 can automatically select a viewing device 114 from the possible viewing devices 114 based on the ranking (e.g., select a highest-ranked viewing device 114). In other examples, the searching device 112 can show a user a menu that includes a list of the possible viewing devices 114 arranged based on the ranking and the user can select a viewing device 114 from the list.

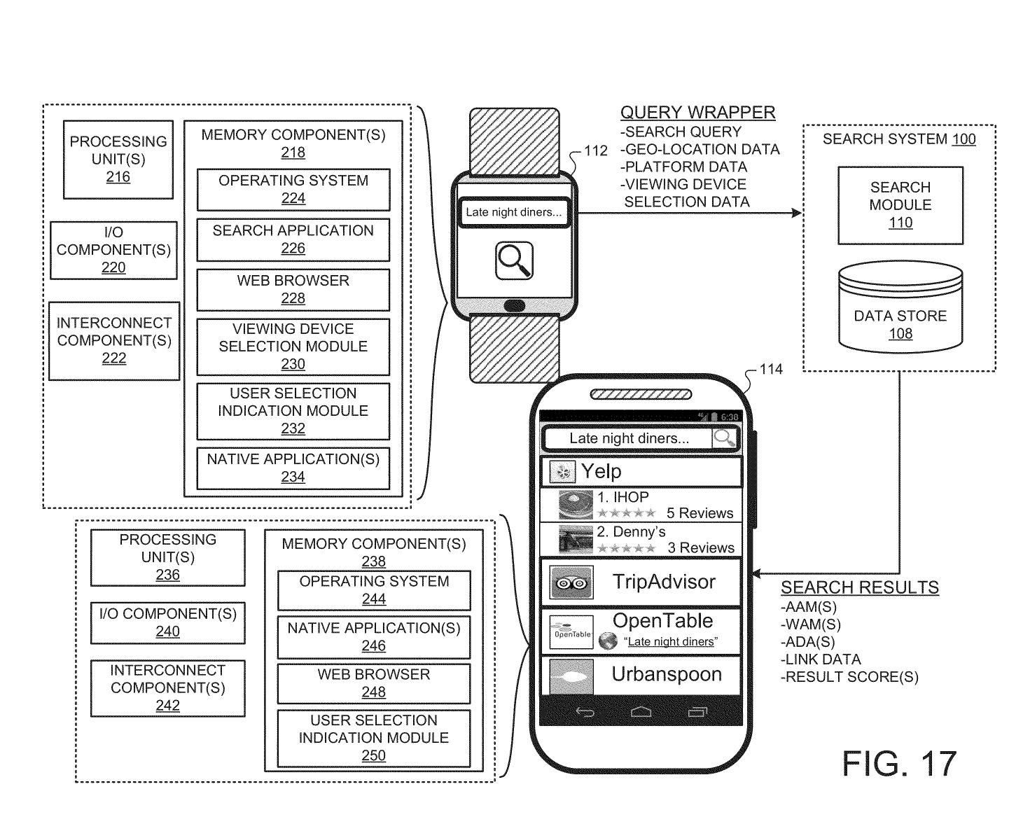

FIG. 17 is a functional block diagram of an example searching device 112 and an example viewing device 114 in communication with the search system 100, consistent with the techniques of the present disclosure. As shown in FIG. 17, the searching device 112 includes one or more processing units 216, memory components 218, input/output (I/O) components 220, and interconnect components 222. The memory component(s) 218 store an OS 224, a search app 226, a web browser app 228, a viewing device selection module 230, a user selection indication module 232, and one or more native apps 234 (e.g., native apps installed on the searching device 112). As also shown in FIG. 17, the viewing device 114 includes one or more processing units 236, memory components 238, I/O components 240, and interconnect components 242. The memory component(s) 238 store an OS 244, one or more native apps 246 (e.g., native apps installed on the viewing device 114), a web browser app 248, and a user selection indication module 250. Each of the processing unit(s) 216, 236 may be configured to execute instructions stored in the corresponding ones of the memory component(s) 218, 238 and communicate with the corresponding ones of the memory component(s) 218, 238 and I/O component(s) 220, 240 (e.g., via the corresponding ones of the interconnect component(s) 222, 242). Each of the OS 224, 244, search app 226, web browser app 228, 248, viewing device selection module 230, user selection indication module 232, 250, and native app(s) 234, 246 may be embodied in computer-executable instructions and executed by the corresponding ones of the processing unit(s) 216, 236. The memory component(s) 218, 238 may be configured to store executable instructions, system parameters, and other data in addition to the contents described above. Each of the I/O component(s) 220, 240 may be configured to (e.g., at the direction of the corresponding ones of the processing unit(s) 216, 236) receive inputs to the corresponding one of the searching and viewing devices 112, 114 and transmit outputs from corresponding one of the devices 112, 114. The interconnect component(s) 222, 242 (e.g., a bus) may be configured to provide communication between the corresponding ones of the processing unit(s) 216, 236, memory component(s) 218, 238, and L/O component(s) 220, 240, as well as among other devices.

The units, components, and modules of the searching and viewing devices 112, 114 described above may enable each of the devices 112, 114 to perform the techniques attributed to the device according to this disclosure. For example, the searching device 112 (e.g., the processing unit(s) 216 executing instructions stored in the memory component(s) 218) may be configured to receive (e.g., via the I/O component(s) 220) a search query 300 from a user, transmit (e.g., via the I/O component(s) 220) the query 300 to the search system 100, and select (e.g., based on a user input, or other data received via the I/O component(s) 220) the viewing device 114 from among a plurality of viewing devices 114, as described herein. To perform one or more of receiving the search query 300, transmitting the query 300, and selecting the viewing device 114, the processing unit(s) 216 may execute one or more instructions included in the memory component(s) 218. For example, the processing unit(s) 216 may execute instructions associated with one or more of the OS 224, search app 226, web browser app 228, viewing device selection module 230, and native app(s) 234. In a specific example, the processing unit(s) 216 may execute instructions that cause the searching device 112 to run the OS 224. To receive the search query 300 and transmit the query 300, the processing unit(s) 216 may further execute instructions that cause the searching device 112 to run the search app 226, web browser app 228, or a native app 246 within the OS 224. In some examples, to select the viewing device 114, the processing unit(s) 216 executes instructions that cause the searching device 112 to run the viewing device selection module 230, e.g., also within the OS 224. The viewing device selection module 230 may be a dedicated software module configured to select a viewing device 114 from among a plurality of viewing devices 114, e.g., based on a user input, or other considerations, as described herein. As shown in FIG. 17, in some examples, the searching device 112 transmits viewing device selection data that identifies the selected viewing device 114 to the search system 100 (e.g., as part of a query wrapper that includes geo-location data and platform data associated with the searching device 112). The search system 100 may use the viewing device selection data to transmit search results 308 generated by the search system 100 using the search query 300 received from the searching device 112 to the viewing device 114.

The viewing device 114 (e.g., the processing unit(s) 236 executing instructions stored in the memory component(s) 238) may be configured to receive (e.g., via the I/O component(s) 240) the search results 308 (e.g., AAMs, WAMs, ADAs, link data, and/or result scores) that are responsive to the search query 300 from the search system 100 and display (e.g., via the I/O component(s) 240) the results 308 to the user, as described herein. The viewing device 114 may be further configured to receive (e.g., via the I/O component(s) 240) a user selection of one of the search results 308 from the user and transmit (e.g., via the I/O component(s) 240) an indication of the user selection to a performing device 116 (not shown), as also described herein. To perform one or more of receiving the search results 308, displaying the results 308, receiving the user selection of one of the results 308, and transmitting the indication of the user selection, the processing unit(s) 236 may execute one or more instructions included in the memory component(s) 238. For example, the processing unit(s) 236 may execute instructions associated with one or more of the OS 244, web browser app 248, user selection indication module 250, and native app(s) 246. In a specific example, the processing unit(s) 236 may execute instructions that cause the viewing device 114 to run the OS 244. To receive the search results 308, display the results 308, and receive the user selection of one of the results 308, the processing unit(s) 236 may further execute instructions that cause the viewing device 114 to run the web browser app 248 or a native app 246 (e.g., a search result viewing app) within the OS 244. In some examples, to transmit the indication of the user selection, the processing unit(s) 236 executes instructions that cause the viewing device 114 to run the user selection indication module 250, e.g., also within the OS 244. The user selection indication module 250 may be a dedicated software module configured to transmit indications of user selections of search results 308 on the viewing device 114 to a performing device 116, as described herein. The performing device 116 (not shown) may be configured to receive the indication from the viewing device 114 and perform a function indicated by the one of the search results 308 selected by the user in response to receiving the indication. In the example of FIG. 17, the performing device 116 may be any of the searching device 112, the viewing device 114, or another device. In examples where the performing device 116 is one of the searching and viewing devices 112, 114, to perform one or more of receiving the indication and performing the function, the corresponding ones of the processing unit(s) 216, 236 may execute one or more instructions included in the corresponding ones of the memory component(s) 218, 238. For example, the processing unit(s) 216, 236 may execute instructions associated with one or more of the OS 224, 244, search app 226, web browser app 228, 248, user selection indication module 232, 250, and native app(s) 234, 246. In a specific example, the processing unit(s) 216, 236 may execute instructions that cause one of the searching and viewing devices 112, 114 to run one of the OS 224, 244. To receive the indication, the processing unit(s) 216, 236 may further execute instructions that cause the searching or viewing device 112, 114 to run one of the user selection indication module 232, 250 within the OS 224, 244. The user selection indication module 232, 250 may be a dedicated software module configured to receive indications of user selections of search results 308 on the viewing device 114 at the performing device 116 (e.g., at one of the searching and viewing devices 112, 114). To perform the function, the processing unit(s) 216, 236 may execute instructions that cause the searching or viewing device 112, 114 to run a native app 234, 246, or the web browser app 228, 248, within the OS 224, 244.

The modules and data stores included in the search system 100 represent features that may be included in the system 100 as it is described in the present disclosure. For example, the search module 110, query analysis module 302, set generation module 304, set processing module 306, and data store 108 may represent features included in the search system 100. The modules and data stores described herein may be embodied by electronic hardware, software, firmware, or any combination thereof. Depiction of different features as separate modules and data stores does not necessarily imply whether the modules and data stores are embodied by common or separate electronic hardware, software, or firmware components. In some examples, the features associated with the one or more modules and data stores depicted herein are realized by common or separate electronic hardware, software, and/or firmware components.

The modules and data stores may be embodied by electronic hardware, software, and/or firmware components including one or more processing units, memory components, input/output (I/O) components, and interconnect components. The interconnect components may be configured to provide communication between the one or more processing units, memory components, and I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with the one or more memory components and I/O components (e.g., communicate with the memory components and I/O components via the interconnect components).

A memory component, or memory, of the present disclosure may include any volatile or non-volatile media. For example, the memory may include electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc (CD), digital versatile disc (DVD), and/or Blu-ray Disc), or any other memory components.

The one or more memory components may include (e.g., store) the data described herein. For example, the one or more memory components may include the data included in the function records of the data store 108. The one or more memory components may also include instructions that may be executed by the one or more processing units. For example, the one or more memory components may include computer-readable instructions that, when executed by the one or more processing units, cause the processing units to perform the various functions attributed to the modules and data stores described herein.

The one or more I/O components may refer to electronic hardware, software, and/or firmware that provides communication with a variety of different devices. For example, the one or more I/O components may provide communication between other devices and the one or more processing units and memory components. In some examples, the one or more I/O components are configured to communicate with a computer network. For example, the one or more I/O components may be configured to exchange data over a computer network using various different physical connections, wireless connections, and protocols. The one or more I/O components may include network interface components (e.g., a network interface controller), repeaters, network bridges, network switches, routers, and firewalls. In some examples, the one or more I/O components include hardware, software, and/or firmware configured to communicate with various human interface devices, including display screens, keyboards, pointer devices (e.g., a mouse), touchscreens, speakers, and microphones. In some examples, the one or more I/O components include hardware, software, and/or firmware configured to communicate with additional devices, such as external memory (e.g., external HDDs).

In some implementations, the search system 100 is a system of one or more computing devices (e.g., a computer search system) configured to implement the techniques described herein. Put another way, the features attributed to the modules and data stores described herein may be implemented by one or more computing devices. Each computing device may include any combination of electronic hardware, software, and/or firmware described above. For example, each computing device may include any combination of the processing units, memory components, I/O components, and interconnect components described above. The one or more computing devices of the search system 100 may also include various human interface devices, including display screens, keyboards, pointing devices (e.g., a mouse), touchscreens, speakers, and microphones. The computing devices may also be configured to communicate with additional devices, such as external memory (e.g., external HDDs).

The one or more computing devices of the search system 100 may be configured to communicate with the network 106. The computing devices may also be configured to communicate with one another via a computer network. In some examples, the computing devices include one or more server computing devices configured to communicate with the user devices 102 (e.g., receive search queries 300 and transmit search results 308), gather data from data sources, index the data, store the data, and/or store other documents. The computing devices may reside within a single machine or multiple machines at a single geographic location, or be distributed across a number of geographic locations.

Additionally, the various implementations of the search system 100 described above (e.g., using one or more computing devices that include one or more processing units, memory components, I/O components, and interconnect components) are equally applicable to any of the searching device 112, viewing devices 114, and performing device(s) 116) described herein.

What is claimed is:

1. A method comprising:
transmitting, using a searching device, a search query to a search system configured to generate search results in response to a received search query;
selecting, using the searching device, one of a plurality of viewing devices;
receiving search results from the search system at the one of the plurality of viewing devices in response to transmitting the search query, wherein each search result indicates a function for a computing device to perform;
displaying the search results on the one of the plurality of viewing devices;
receiving a user selection of one of the search results at the one of the plurality of viewing devices; and
transmitting, using the one of the plurality of viewing devices, an indication of the user selection to a performing device, wherein the performing device is configured to perform the function indicated by the one of the search results in response to receiving the indication.

2. The method of claim 1, wherein selecting the one of the plurality of viewing devices comprises receiving a user selection of a viewing device of the plurality of viewing devices at the searching device, and selecting the viewing device as the one of the plurality of viewing devices based on the user selection.

3. The method of claim 2, further comprising displaying an indication of the viewing device of the plurality of viewing devices on the searching device, wherein receiving the user selection of the viewing device comprises receiving a user selection of the indication at the searching device.

4. The method of claim 3, further comprising displaying an indication of each of one or more of the following on the searching device: (1) a location of the viewing device of the plurality of viewing devices; (2) whether the viewing device is available to display the search results; (3) whether the viewing device is capable of displaying the search results; (4) whether the viewing device is connected to the searching device via a communication interface; (5) whether the viewing device has been previously connected to the searching device via a communication interface; (6) whether the viewing device has been previously selected by the searching device; and (7) how frequently the viewing device has been previously selected by the searching device.

5. The method of claim 1, further comprising receiving an indication of one or more potential viewing devices that include the one of the plurality of viewing devices from a user at the searching device, wherein selecting the one of the plurality of viewing devices comprises selecting the one of the plurality of viewing devices based on the indication.

6. The method of claim 1, wherein selecting the one of the plurality of viewing devices comprises receiving location data that indicates a location of each of one or more of the plurality of viewing devices, and selecting the one of the plurality of viewing devices based on the location data.

7. The method of claim 6, wherein selecting the one of the plurality of viewing devices based on the location data comprises identifying a viewing device of the plurality of viewing devices that is located most proximate to the searching device using the location data, and selecting the viewing device as the one of the plurality of viewing devices.

8. The method of claim 1, wherein selecting the one of the plurality of viewing devices comprises receiving availability data that indicates whether each of one or more of the plurality of viewing devices is available to display the search results, and selecting the one of the plurality of viewing devices based on the availability data.

9. The method of claim 1, wherein selecting the one of the plurality of viewing devices comprises receiving compatibility data that indicates whether each of one or more of the plurality of viewing devices is capable of displaying the search results, and selecting the one of the plurality of viewing devices based on the compatibility data.

10. The method of claim 9, wherein the compatibility data indicates one or more of a display technology, a display resolution, and a display size associated with each of the one or more of the plurality of viewing devices, the method further comprising determining one or more of a display technology, a display resolution, and a display size associated with the search results, wherein selecting the one of the plurality of viewing devices based on the compatibility data comprises selecting the one of the plurality of viewing devices based on the compatibility data and based on the determination.

11. The method of claim 1, wherein selecting the one of the plurality of viewing devices comprises receiving connectivity data that indicates whether each of one or more of the plurality of viewing devices is connected to the searching device via a communication interface, and selecting the one of the plurality of viewing devices based on the connectivity data.

12. The method of claim 1, wherein selecting the one of the plurality of viewing devices comprises receiving historical connectivity data that indicates whether each of one or more of the plurality of viewing devices has been previously connected to the searching device via a communication interface, and selecting the one of the plurality of viewing devices based on the historical connectivity data.

13. The method of claim 1, wherein selecting the one of the plurality of viewing devices comprises receiving previous selection data that indicates whether each of one or more of the plurality of viewing devices has been previously selected by the searching device, and selecting the one of the plurality of viewing devices based on the previous selection data.

14. The method of claim 1, wherein selecting the one of the plurality of viewing devices comprises receiving previous selection data that indicates how frequently each of one or more of the plurality of viewing devices has been previously selected by the searching device, and selecting the one of the plurality of viewing devices based on the previous selection data.

15. The method of claim 1, wherein the one of the search results includes an access mechanism, and wherein to perform the function indicated by the one of the search results, the performing device is configured to set an application into a state of the application using the access mechanism.

16. The method of claim 1, wherein to perform the function indicated by the one of the search results, the performing device is configured to:
display an expanded version of the one of the search results to a user;
receive a selection of the expanded version from the user; and
perform the function indicated by the one of the search results in response to receiving the selection.

17. The method of claim 1, wherein the performing device and the searching device are the same device.

18. The method of claim 1, wherein the performing device and the one of the plurality of viewing devices are the same device.

19. A system comprising:
a searching device;
a plurality of viewing devices;
a performing device; and
a search system, wherein the search system is configured to receive a search query from the searching device and transmit search results that are responsive to the search query, wherein the searching device is configured to select one of the plurality of viewing devices, wherein the one of the plurality of viewing devices is configured to receive the search results from the search system, display the search results to a user, receive a user selection of one of the search results from the user, and transmit an indication of the user selection to the performing device, and wherein the performing device is configured to perform a function indicated by the one of the search results in response to receiving the indication.

20. A non-transitory computer-readable storage medium comprising instructions that cause one or more computing devices to:
transmit, using a searching device, a search query to a search system configured to generate search results in response to a received search query;
select, using the searching device, one of a plurality of viewing devices;
receive search results from the search system at the one of the plurality of viewing devices in response to transmitting the search query, wherein each search result indicates a function for a computing device to perform;
display the search results on the one of the plurality of viewing devices;
receive a user selection of one of the search results at the one of the plurality of viewing devices; and
transmit, using the one of the plurality of viewing devices, an indication of the user selection to a performing device, wherein the performing device is configured to perform the function indicated by the one of the search results in response to receiving the indication.
